(19) United States
(12) Patent Application Publication
(10) Pub. No.: US 2024/0394532 A1
(43) Pub. Date: Nov. 28, 2024

(54) DATA AUGMENTATION FOR TRAINING NEURAL NETWORKS

(71) Applicants: NAVER CORPORATION, Seongnam-si (KR); NAVER LABS CORPORATION, Seongnam-si (KR)

(72) Inventors: Juliette MARRIE, Meylan (FR); Michael ARBEL, Meylan (FR); Julien MAIRAL, Biviers (FR); Diane LARLUS, Meylan (FR)

(21) Appl. No.: 18/634,466

(22) Filed: Apr. 12, 2024

Related U.S. Application Data
(60) Provisional application No. 63/504,395, filed on May 25, 2023.

(51) Int. Cl. G06N 3/08

(52) U.S. Cl. CPC G06N 3/08

(57) ABSTRACT

In methods for training a data augmentation policy represented by data augmentation parameters, a neural network having neural network parameters is pretrained on a task on data augmented by an initial augmentation policy. The data augmentation policy is iteratively trained, wherein the neural network parameters of the neural network are initialized with the neural network parameters trained during the pretraining, the neural network is trained on the task to update the neural network parameters on the data, wherein the data is augmented by the current data augmentation policy for the current step, and the data augmentation policy is updated to define the current data augmentation policy.

### PRIORITY CLAIM

The present application claims priority to and the benefit of U.S. Provisional Application Ser. No. 63/504,395, filed May 25, 2023, which application is incorporated herein by reference in its entirety.

### FIELD

The present disclosure relates generally to machine learning, and more particularly to methods and systems for augmenting data for training neural networks.

### BACKGROUND

Data augmentation of training data (i.e., artificially generating new data from existing data) can improve the generalization of neural networks trained using such data (i.e., data distributions, which may be provided via one or more datasets) in performing various tasks. However, good results require that the set of transformations be chosen with care, a selection often performed manually, e.g., as the result of a long-standing effort made of manual trial-and-errors.

For example, augmenting a dataset of image data by transforming the images can enhance training for models that process images. Data augmentation that encourages predictions to be stable with respect to particular image transformations has become an essential component in visual recognition systems. While the typical data augmentation process for images is conceptually simple, selecting an optimal set of image transformations for a given task or dataset is challenging. Designing a good set of image training data in particular domains (i.e., areas of data distributions or wider data distributions, which may, but need not, correspond to categories, contexts, or environments) can be the result of substantial research and effort. However, while data augmentation strategies may be chosen by hand for one domain and used successfully, say, for recognition tasks involving natural images, the same strategies may fail to generalize to other contexts such as different natural image datasets, or even more challenging domains such as medical imaging, remote sensing, hyperspectral imaging, etc.

These and other concerns have motivated those in the art to attempt to automate the design of data augmentation strategies so as to automatically learn an optimal data augmentation strategy for a specific task or dataset. Such augmentation strategies are often represented as a stochastic policy that randomly draws a combination of transformations along with their magnitudes from a large predefined set each time an image is sampled (or a data sample is observed).

A goal thus becomes learning strategies that effectively compose multiple transformations, which is a challenging task given the large search space of augmentations. Significant choices for such strategies include the parametrization of a data augmentation policy (that is, the choice of the transformations that are combined, the probability distribution used to select transformations, etc. for improving training data diversity) and learning methods (which can incorporate one or more algorithms) used to train the parameters of the data augmentation policy.

However, current approaches for automatically designing data augmentation strategies have been insufficient.

### SUMMARY

Provided herein, among other things, are computer-implemented methods for training a data augmentation policy, which methods may be performed using a processor (generally, one or more processors). A neural network having neural network parameters is pretrained on a task on a training dataset, the training dataset being augmented by an initial augmentation policy. The data augmentation policy can be initialized with the initial data augmentation policy to define a current data augmentation policy. The data augmentation policy is iteratively trained over n rounds, where n is at least 1, in which: the neural network parameters of the neural network are initialized with the neural network parameters trained during the pretraining; and, over a plurality of steps: the neural network is trained on the task to update the neural network parameters on the training dataset, wherein the training dataset is augmented by the current data augmentation policy for the current step; and the data augmentation policy is updated to define the current data augmentation policy for the next step or the data augmentation policy on the last round.

According to a complementary aspect, the present disclosure provides a computer program product, comprising code instructions to execute a method according to the previously described aspects; and a computer-readable medium, on which is stored a computer program product comprising code instructions for executing a method according to the embodiments and aspects described herein. The present disclosure further provides a processor configured using code instructions for executing a method according to the described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example method for finding a policy that can be used for training a neural network to perform a task.

FIG. 2 shows steps in an example method for learning an optimal policy during a search phase.

FIG. 3 shows information flow for an example training operation.

FIG. 4 shows an algorithm for implementing an example method.

FIG. 5A shows a method for training a neural network model on a task using a trained data augmentation policy.

FIG. 5B illustrates example transformations for an experimental operation of an example training method.

FIG. 6 shows example learned policies found on DomainNet for the best search split as pie charts. Gray circle: initial magnitude upper-bounds. Radius of each pie: learned upper-bounds. Size of each pie: probability of each transformation, averaged over the three composite distributions.

FIG. 7 shows evolution of probability distributions for CIFAR10 and CIFAR100 and pie charts of the final policies in experimental methods.

FIG. 8 shows the best policy found for ImageNet-100 in experiments.

FIG. 9 shows pie charts illustrating policies found by a present embodiment inventive method (referred to as SLACK) on DomainNet.

FIG. 10 shows evolution of probability distributions π for CIFAR100 with unregularized unrolled optimization in a case of collapse, where the three left images show the three distributions over transformations forming the composition, and the right image shows an average of the three distributions.

FIG. 11 shows evolution of probability distributions π for CIFAR100 with entropy-regularized unrolled optimizations, on one of the search splits, where the three left images show the three distributions over transformations forming the composition, and the right image shows an average of the three distributions.

FIGS. 12-13 show the evolution of example probability distributions it for CIFAR100 under an unregularized multi-stage search using upper-level learning rates of 0.25 and 0.5, where the three left images show the three distributions over transformations forming the composition, and the right image shows an average of the three distributions.

FIG. 14 shows an example architecture in which example methods can be implemented.

In the drawings, reference numbers may be reused to identify similar and/or identical elements.

### DETAILED DESCRIPTION

Automatic data augmentation aims at automating the process of selecting the optimal data augmentation strategies, such as the “right” transformations. For image transformation, for example, automatic data augmentation methods have achieved state-of-the-art results on common benchmarks such as CIFAR and ImageNet. However, automatic data augmentation approaches in the art still rely on strong prior information. For example, prior approaches start from a pool of manually-selected “default” transformations that are either used to pretrain the network or are forced to be part of the policy learned by the automatic data augmentation algorithm, e.g., by serving as base transformations upon which remaining ones are learned.

A common way to improve stability and make the automatic data augmentation problem simpler is to reduce the search space. This is often achieved by learning the augmentation policy on top of default transformations such as (for images) Cutout, random cropping and resizing, or color jittering, all known to be well suited to natural images, which compose standard benchmarks (such as CIFAR or ImageNet), or by discarding transformations known to be harmful (such as Invert). Fixing some of the transformations and removing others can mitigate the challenges inherent to learning a composition of transformations. It has also been shown that state-of-the-art results can be achieved on these benchmarks by directly applying the policy classically used for initializing auto-augmentation models, up to minor modifications.

Conventional methods further rely on carefully selected ranges that constrain the transformation's magnitudes. Despite their effectiveness, however, manually selecting default transformations and magnitude ranges restricts the applicability of such policies to natural images and prevents generalization to other domains.

Designing automatic data augmentation approaches introduces various challenges. For example, the parametrization should be expressive enough and provide a rich class of transformations. The computational cost of the learning method should be reasonable and impose minimal or no limitation on the dataset size. A learning method should also be able to work with as little prior information as possible.

Example methods and systems herein can directly learn an augmentation policy for generating augmented data, including but not limited to updating an unrestricted or arbitrary initial augmentation policy (essentially, any augmentation policy), without the need to leverage prior knowledge as required in prior methods.

In example methods, this can be achieved by solving a bilevel optimization problem. Bilevel optimization is a useful framework for learning the parameters of a policy. For instance, one could look for the best possible policy such that a neural network trained with this policy on a training dataset (an inner problem or lower-level problem) generalizes well on a distinct validation dataset (an outer problem or upper-level problem). Optimizing the resulting formulation is challenging, as the outer problem depends on the solution of the inner problem.

One possible technique for solving this bilevel problem is unrolled optimization, though other optimization methods are possible. “Unrolled optimization” as used herein refers generally to approximating the optimal inner-level solution of the bilevel problem using a sequence of differentiable optimization steps. Example unrolled optimization methods for solving bilevel problems are disclosed in, for instance, Lecouat et al., A flexible framework for Designing Trainable Priors with Adaptive Smoothing and Game Encoding, NeurIPS2020; Michael Arbel and Julien Mairal. Non-convex bilevel games with critical point selection maps. preprint arXiv:2207.04888, 2022; and Baydin et al., Automatic Differentiation in machine learning: a survey, JMLR 2017, though other unrolled optimization methods are possible. However, unrolled optimization can become highly unstable as the neural network weights become progressively suboptimal for the current policy during the learning process.

Further, stochastic policies typically require a discrete parametrization, making gradient-based optimization methods not directly applicable in some prior methods. Augmentations are often non-differentiable in the parameters of the policy, thus requiring techniques other than direct differentiation, such as Bayesian optimization, gradient approximations (e.g., RELAX), or a score method/REINFORCE algorithm. While these techniques bypass the differentiability issues, they can suffer from large bias or variance.

To mitigate possible instabilities and high variance estimates that may arise due to the larger search space and the inherent instability of bilevel optimization algorithms, example training methods can employ a successive cold-start approach and/or a divergence or entropy-based regularization such as but not limited to Kullback-Leibler (KL) regularization that encourages exploration and diversity between subsequently applied data augmentations. Such methods can improve the stability of the process for learning the data augmentation policy. For instance, an example multi-stage training method can first pre-train a neural network with a data augmentation policy using a default sampling, e.g., uniformly sampling over all data augmentations (e.g., image transformations), though essentially any other default sampling may be used. Then each training stage can use a cold-start approach, in which each stage restarts from the pre-trained neural network and performs incremental updates of the current policy.

Additionally, example approaches can parameterize magnitudes for data augmentations (e.g., image transformations) as continuous distributions instead of discrete values and estimate these continuous distributions, providing more versatile modeling for an augmentation policy. In some example methods, score/REINFORCE techniques are employed to compute the gradient of the policy, and unrolled optimization is employed to learn the policy, as part of solving the bilevel (inner and outer, or lower-level and upper-level) optimization problem. Example multi-stage approaches with cold start can prevent the neural network from becoming progressively suboptimal as the policy is updated using unrolled optimization. Divergence or entropy-based regularization can define a trust region for the policy to compensate for a possibly high variance of gradient estimates obtained using a Score/REINFORCE technique, and it encourages exploration during training, preventing collapse to trivial solutions.

Example methods and systems herein allow the selection of augmentation strategies without relying on default augmentation policies, such as policies including default augmentations (e.g., transformations) or hand-selected magnitude ranges (e.g., ranges known to suit common benchmarks). Instead, augmentation policies can be directly learned from an unrestricted or arbitrary augmentation policy. An example learning method can provide an interpretable model for augmentation policies that allows learning both the frequency by which a given augmentation is selected and the magnitude by which it is applied.

Example methods and systems can be incorporated into any of various applications in which data augmentation can be used to improve the generalization of neural networks. As a nonlimiting example, image transformation is a crucial component in a variety of computer vision applications, such as but not limited to image classification systems. Providing an optimal data augmentation policy automatically via direct learning as provided in embodiments herein, as opposed to manually tuning the data augmentation policy, can reduce the deployment time of visual systems, as a particular example.

The choice of image transformation has become central in applications such as, but not limited to, the design of computer vision pipelines. To remove the burden of manual selection, automatic data augmentation strategies have been proposed. For instance, a previously disclosed method, AutoAugment, uses a recurrent neural network (RNN) for designing an augmentation policy. Because such an approach requires pretraining a prediction model at each iteration, it is prohibitively slow.

More efficient alternatives have aimed at reducing the training cost using, for example, population-based training, Bayesian optimization, or, more recently, gradient-based approaches based on bilevel optimization. Examples of the latter approaches rely on various gradient estimation techniques such as RELAX or the Score method. However, RELAX is inherently biased, while the Score method is theoretically exact, but has a high variance when approximated in the context of stochastic optimization. Therefore, these approximations may lead to diverging gradient updates. By contrast, example methods herein can alleviate this by introducing a divergence regularization, such as a KL regularization, which defines a trust region for the policy.

Many prior methods learn augmentation policies using a small network learned on a subset of the dataset of interest, before retraining the prediction model on a larger network using the full (augmented) data. This strategy is appealing to more recent gradient-based methods, as the search phase for an augmentation policy is often reduced to minutes. However, augmentation policies found using such a reduced setup may be suboptimal compared to approaches exploiting full datasets for training both the augmentation policy and the prediction model. While a naïve grid search, for example, has been found to yield improved results when directly training on both the full-size network and the full data, such results are obtained at the expense of using strong prior knowledge, in which augmentation policies are applied on top of default transformations that are manually and independently chosen for each benchmark. In other example methods, with a few additional careful choices regarding the augmentation policies, applying a single random transformation on top of the default ones can lead to improved results.

Other methods avoid relying on default augmentations by using a greedy approach that is able to learn these transformations. However, learning is performed after a “pretraining” phase leveraging the usual default transformations. Further, while such a greedy approach simplifies the search procedure and reduces its stochasticity, the resulting computational cost is high. By contrast, example methods herein can improve stability and allow directly learning the joint probability of sampling multiple transformations, reducing the search time greatly (e.g., two-fold) compared to methods using greedy approaches.

For illustrating inventive features, an example regularized multi-stage approach combined with an interpretable model of the augmentation policies, referred to as SLACK (Stable Learning of Augmentations with Cold-start and Kullback-Leibler regularization), is described in more detail herein. This combined approach provides an efficient data augmentation learning method that can address the otherwise challenging bilevel optimization problem of learning a stochastic data augmentation policy without relying strongly on prior knowledge. Experimental results using SLACK, described in more detail below, demonstrate that example training methods can provide competitive results on standard benchmarks despite a more challenging setting. Further, example training methods allow generalizing to domains beyond those provided in a default training dataset.

### ILLUSTRATIVE EXAMPLE

Example methods will now be described with respect to training neural network models for image classification where the data augmentation is provided by image transformation to illustrate inventive features. However, it will be appreciated that inventive methods are likewise applicable for neural network models that perform other tasks and/or are trained using other types of data, and/or data that are augmented in other ways.

Example methods herein define an augmentation policy, which is a probabilistic model (or stochastic model) for generating data augmentations. Methods learn the parameters of this augmentation policy to improve the performance of the neural network model, such as but not limited to a trained classifier for images, on a separate (or disjoint) dataset, e.g., a held-out dataset.

Augmentation functions: Formally, an augmentation function τ transforms an image x into another, augmented image τ(x), e.g., of the same dimensions. Consider composite augmentations obtained by combining simpler augmentations selected from a finite set [symbol] ={s₁, . . . , s_{N}} of N candidate elementary transformations, such as rotations, translations, shearing, etc. Each elementary transformation, for example, can depend on a magnitude parameter m that controls the strength of the transformations, for instance, the angle by which an image is rotated. Magnitudes may be (but need not be) normalized, e.g., to be in the unit interval [0,1].

Augmentation policy: The augmentation policy may be defined as a stochastic or probabilistic model p_{ϕ}, that generates composite augmentations given some parameter ϕ to be learned, and thus may be referred to as an augmentation model. An example augmentation model generates an augmentation in three steps: (1) it samples K elementary transformations t1, . . . , tₓ from [symbol] according to a categorical distribution p_{π} of parameter π; (2) it samples values for the magnitudes m₁, . . . , mₓ for each of the selected elementary transformations tₖ according to a smoothed uniform distribution p_{μ} of parameter μ; and (3) it composes the K elementary transformations to obtain the composite augmentation, with each tₖ applied using its corresponding magnitude mₖ. Therefore, the augmentation policy p_{ϕ}(τ) can take the form:

$${p}_{ϕ} ( τ ) = {\prod }_{i = 1}^{K} {p}_{π} ( {t}_{i} ) {p}_{μ} ( {m}_{i} \vert {t}_{i} ) , \qquad ( 1 )$$

Where the parameters ϕ=(π,μ) are learned jointly.

Sampling transformations: Example augmentation models sample elementary transformations tₖ with replacement from a categorical distribution Cat_{π}_{ₖ} of dimension N parameterized by a logit vector πₖ:=(π_{k,n})_{1≤n≤N}. The probability pₙ(t₁, . . . , t_{K}) of sampling the K transformations is given by:

$${p}_{π} ( {t}_{1} , … , {t}_{K} ) = {\prod }_{k = 1}^{K} C a {t}_{{π}_{k}} ( {t}_{k} ) , \qquad ( 2 )$$

Where all logits are collected to form a parameter matrix π of size K×N. These parameters may be learned.

Sampling magnitudes: The magnitudes of each elementary transformation sᵢ in S are sampled from a smoothed uniform distribution between [0,μᵢ] whose upper bound μᵢ is learned. More precisely, the distribution's density may be defined as:

$${p}_{{μ}_{i}} ( {m}_{i} ) = \frac{1}{{μ}_{i}} {\int }_{0}^{{μ}_{i}} 𝒩 ( {m}_{i} , σ ) ( u ) du ,$$

Where [symbol] (mᵢ,σ) is the Gaussian distribution of mean mᵢ and deviation σ. The density pu (mi) approximates the uniform distribution 1/μᵢ 1_{[0,μ}_{ᵢ}_{]} as the deviation σ approaches 0. Example methods set σ=0.1, as this has been found to achieve a good trade-off between smoothing and approximation, though this deviation can be larger or smaller. Uniform sampling provides results comparable to more elaborate sampling approaches, with the magnitude range having more impact on the results, though distributions other than uniform distributions may be used.

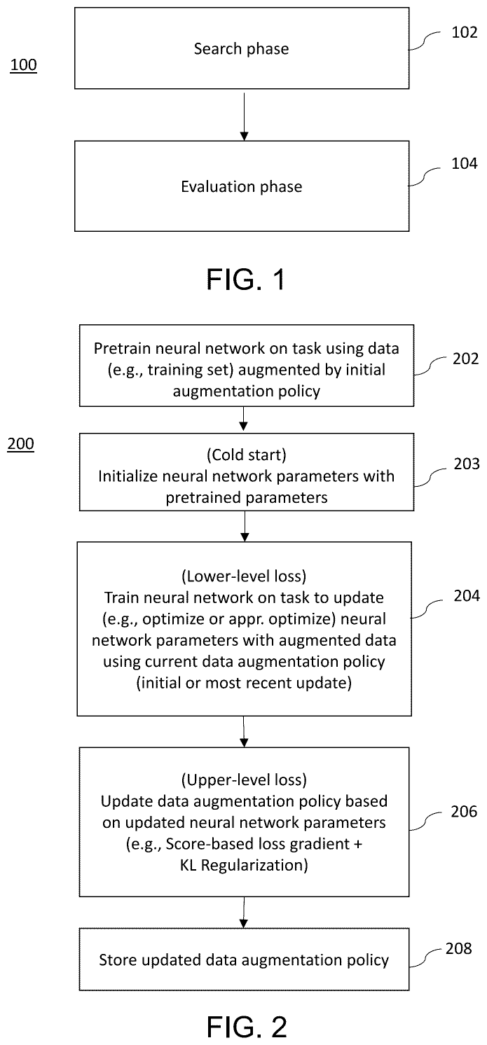

Bilevel formulation for policy search: FIG. 1 shows an example method 100 for finding a policy that can be used for training a neural network to perform a task. Consider a prediction task, such as predicting the class y of some natural image x using a model f_{θ}(x) with parameter θ. A goal is to find the best augmentation policy parameter ϕ, corresponding to the best augmentation policy p_{ϕ}, so that the prediction model f_{θ}, when trained using such policy on a training set [symbol] of input/output pairs (x,y), generalizes well on a disjoint (i.e., non-overlapping, or separate) dataset such as a test set [symbol] ₜₑₛₜ.

This problem naturally decomposes in two phases. During a search phase 102, the optimal augmentation policy p_{ϕ} is learned on [symbol] . During an evaluation phase 104, the model is retrained on D using p_{ϕ} and is then evaluated on Dₜₑₛₜ.

The evaluation phase 104 can be performed using, e.g., standard optimization methods, as will be appreciated by those of ordinary skill in the art. However, the search phase 102 involves solving a more complex optimization problem. Particularly, the search phase 102 can be implemented to address a bilevel problem involving two interdependent losses: a lower-level loss [symbol] ₜᵣₐᵢₙ(θ,ϕ) for learning an optimal model parameter θ*(ϕ) obtained using the augmentation policy p_{ϕ} and an upper-level loss [symbol] (ϕ) for learning the policy parameter ϕ by evaluating the optimal model with parameter θ*(ϕ). Each of these objectives can be evaluated on two separate (disjoint, non-overlapping) splits of the available data [symbol] : a training split [symbol] ₜᵣₐᵢₙ for the lower-level loss and a validation split [symbol] ᵥₐₗ for the upper-level loss.

Lower-level loss: The training loss [symbol] ₜᵣₐᵢₙ(θ,τ) when only a fixed augmentation τ is used can be defined as:

$${ℓ}_{t r a i n} ( θ , τ ) := {𝔼}_{( x , y ) ∼ {𝒟}_{train}} [ ℓ ( y , {f}_{θ} ( τ ( x ) ) ) ]$$

Where (x, y) is an (image, label) pair drawn from [symbol] ₜᵣₐᵢₙ and [symbol] is a pointwise prediction loss (e.g., cross-entropy). The training loss [symbol] ₜᵣₐᵢₙ(θ,ϕ) can then be defined for an augmentation policy p_{ϕ} by taking the expectation of [symbol] ₜᵣₐᵢₙ(θ,τ) over augmentations τ sampled according to the policy p_{ϕ}:

$${ℒ}_{t r a i n} ( θ , ϕ ) := {𝔼}_{τ ∼ {p}_{ϕ}} [ {ℓ}_{t r a i n} ( θ , τ ) ]$$

Hence, for a given policy p_{ϕ}, the goal is learning the optimal model parameter θ*(ϕ) by minimizing [symbol] ₜᵣₐᵢₙ(θ,ϕ) over θ.

Upper-level loss: The validation loss [symbol] ᵥₐₗ(θ) for a given model of parameter θ can be defined as:

$${ℒ}_{v a l} ( θ ) := {𝔼}_{( x , y ) ∼ {𝒟}_{v a l}} [ ℓ ( y , {f}_{θ} ( x ) ) ] .$$

The validation loss [symbol] ᵥₐₗ(θ) can be computed over the validation set [symbol] ᵥₐₗ without applying any augmentation, and thus can provide a proxy for the performance on the test dataset. The upper-level loss can then be defined to be the validation loss of an optimal model θ*(ϕ) learned using a policy p_{ϕ}:

$$ℱ ( ϕ ) := {ℒ}_{v a l} ( {θ}^{★} ( ϕ ) ) . \qquad ( 3 )$$

Learning the optimal policy: While optimizing the lower-level loss can be relatively standard, minimizing the upper-level loss [symbol] can be more challenging due to the complex dependence of the optimal model parameter θ*(ϕ) on the policy. This provides a bilevel problem, which can be solved using example methods.

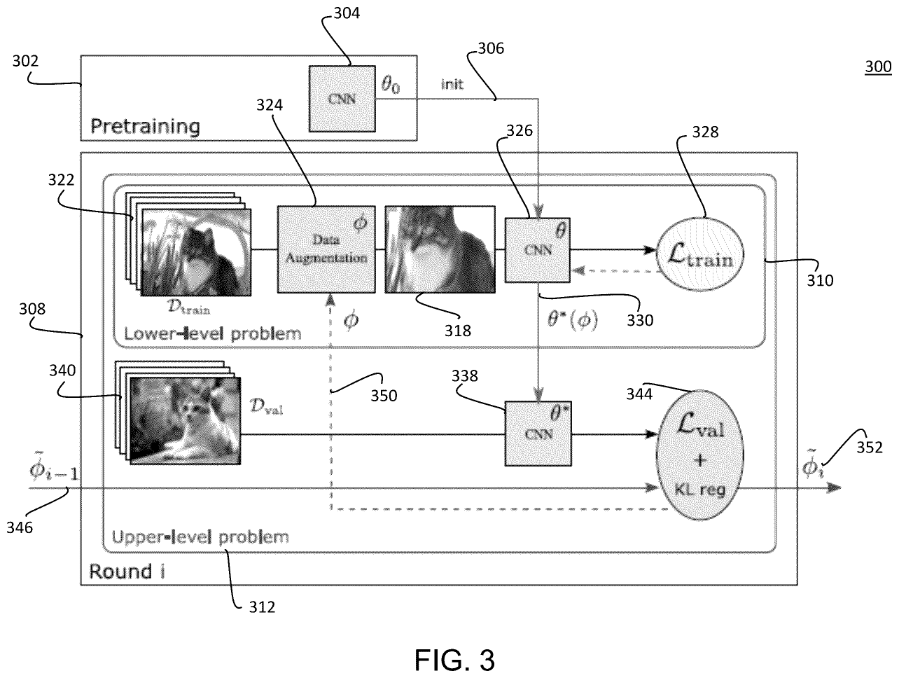

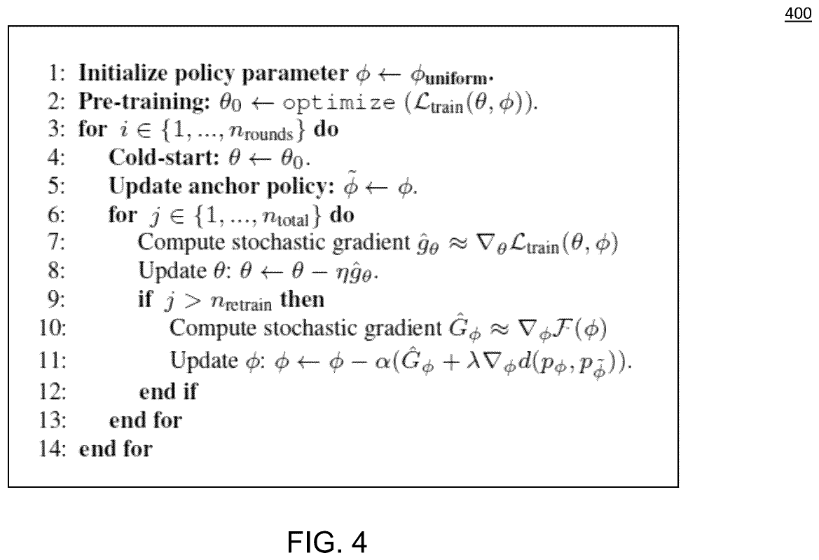

FIG. 2 shows steps in an example method 200 for learning the optimal policy during the search phase, and FIG. 3 shows information flow 300 for an example training operation. The method 200 may be performed, e.g., using a processor (“processor” generally refers to one or more processors). The neural network provided for performing the image classification task is represented in FIG. 3 by a convolutional neural network (CNN). The method 200 first pre-trains the prediction model at 202 on the task using the objective [symbol] ₜᵣₐᵢₙ(θ,ϕ_{uniform}) for an initial data augmentation policy, e.g., parameterized by ϕ_{uniform}, which can be unrestricted or arbitrary. In a nonlimiting example method, the initial data augmentation policy samples uniformly among all elementary transformations. The initial augmentation policy is used to augment data, such as a training set [symbol] ₜᵣₐᵢₙ, that may be split from a larger dataset, such as dataset [symbol] .

The method 200 then performs n_{rounds} (one or more) iterative training rounds to update the parameters θ and ϕ jointly using a bilevel optimization algorithm. In each round, a cold-start may be performed at 203 by initializing neural network parameters with pretrained parameters determined from pretraining step 202. For a first round, the neural network parameters may be already initialized. In subsequent rounds, the initializing may include resetting the neural network parameters to the pretrained parameters from their updated state from a most recent prior round.

Each round further includes determining a lower-level loss at 204 by training the neural network on the task to, e.g., approximately, optimize (or more generally, update) neural network parameters using data provided from a training dataset, e.g., training split [symbol] ₜᵣₐᵢₙ, that is augmented using a current augmentation policy. The current augmentation policy may be, for instance, the most recently updated augmentation policy, such as the initial augmentation policy (e.g., ϕ_{uniform}) if the augmentation policy has not yet been updated, an augmentation policy that was most recently updated after a previous round, which is referred to in example embodiments herein as an anchor policy, or the most recently updated augmentation policy during the current round, as multiple updates may take place during a single round.

An upper-level loss is determined at 206 that updates data augmentation parameters of the data augmentation policy to update the augmentation policy. The data augmentation policy is updated based on the updated, e.g., optimized, neural network parameters. For instance, as set out in further detail herein, a gradient for updating the data augmentation policy is determined at least in part based on a loss provided by the updated neural network model with optimized neural network parameters when this model is evaluated on an evaluation dataset, without data augmentation. The loss may also be determined in part based on regularization, as described in further detail herein. The updated data augmentation policy, which can be defined by or include updated data augmentation parameters, can be stored at 208.

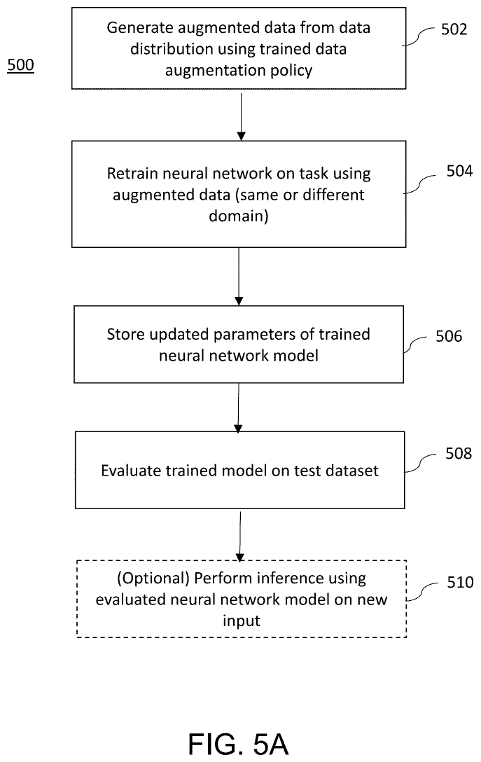

In some example methods, updating the neural network model (e.g., neural network parameters) at 204 and updating the data augmentation policy at 206 may, but need not, occur in a repeated sequence, e.g., over each of a plurality of steps within one or more rounds, as described below with respect to FIG. 4. Additionally, during one or more rounds, example methods may, but need not, update the neural network model (e.g., neural network parameters) at 204 over each of a plurality of steps (e.g., initial steps) within a round, without updating the data augmentation policy therebetween, prior to the repeated sequence of steps (e.g., remaining steps) within a round in which updating the neural network model (e.g., neural network parameters) at 204 and updating the data augmentation policy at 206 are performed, as also described below with respect to FIG. 4. Such separately updating the neural network model at 204 may use training data over each of these additional training steps that is augmented using the current data augmentation policy provided by the data augmentation policy as updated at the end of the prior round (or the initial data augmentation policy in a first round).

During the n_{rounds} training rounds a data augmentation policy parameterized by ϕ is learned using the bilevel operation. As shown in the example information flow 300 on FIG. 3, pretraining 302 of a neural network model 304, e.g., incorporating a convolutional neural network (CNN), is conducted using data, e.g., from a dataset such as but not limited to training split [symbol] ₜᵣₐᵢₙ, that is augmented using the initial augmentation policy, ϕ_{uniform}.

The pretraining 302 provides an initial neural network model θ₀ that is provided (e.g., output) at 306 for iterative training over one or more rounds 308, including an inner loop 310 for solving a lower-level problem and an outer loop 312 for solving an upper level problem. Operation of the inner loop 310 and the outer loop 312 may be performed over one or more steps, e.g., a plurality of steps, in a round. Optionally, operation of the inner loop 310 (without operation of the outer loop 312) may also be performed over one or more, e.g., a plurality of additional, e.g., initial, steps in a round.

During an example iterative training, the lower-level problem is solved in the inner loop 310 by training the neural network model 326 over one or more steps (training steps) to find an updated, e.g., optimal, network parameter θ*. This training uses a training dataset, e.g., a set of images 322 or other data from a training split [symbol] ₜᵣₐᵢₙ that is augmented using a data augmentation model 324 with a current augmentation policy p_{ϕ} for the current step augmentation policy parameters ϕ, providing augmented data 318.

In an initial step of an initial round, the current step augmentation policy parameters ϕ can be initial parameters. In subsequent steps and rounds, the data augmentation policy parameters ϕ for a current step can be the most recently updated parameters, e.g., from a previous step, or from the end of the previous round (e.g., as provided via outer-loop output 350), providing augmented data 318. The lower-level loss [symbol] ₜᵣₐᵢₙ(θ,ϕ) 328 is optimized (e.g., via backpropagation) to learn the optimal model parameter θ*(ϕ) obtained using the augmentation policy p_{ϕ}. The updated neural network model, e.g., the optimal model parameter, may be output 330 to the outer loop 312.

For an (optional) additional operation of the inner loop 310 without operation of the outer loop 312, e.g., over each of the initial steps in a round, the current data augmentation policy p_{ϕ} for the data augmentation model 324 can be provided by the initial augmentation policy in the first round, or for later rounds the data augmentation policy as updated at the end of the previous round (e.g., as provided via outer-loop output 350, which may be the anchor policy \tilde{ϕ}ᵢ₋₁). The same current data augmentation policy can be used for each of these initial steps.

The outer loop 312 trains an optimized neural network 338 on a disjoint (separate) set of images or other data, e.g., a validation dataset [symbol] ᵥₐₗ 340, and finds the optimal transformation parameters ϕ to update the augmentation policy. “Disjoint” refers to the set of images [symbol] ᵥₐₗ being a separate set from the images used to train the neural network model, e.g., [symbol] ₜᵣₐᵢₙ, although both sets may be (but need not always be) taken (e.g., split) from a larger data distribution, e.g., training set [symbol] , as mentioned above. The validation split [symbol] ᵥₐₗ in example methods for training in the outer loop 312 is not augmented by the data augmentation policy (e.g., data augmentation policy 324).

An upper-level loss 344 [symbol] (ϕ):= [symbol] ᵥₐₗ(θ*(ϕ), which may include a regularization loss as provided in more detail below, is used to update the data augmentation policy, and can provide at 350 a new current data augmentation policy for the data augmentation model 324 in the inner loop 310 in a next step within the round 308, or in a first step for a next round. The prior data augmentation policy 346 from the previous round \tilde{ϕ}ᵢ₋₁ provides an anchor policy during the data augmentation policy updates, as also described in further detail below.

At the end of the round i the updated data augmentation policy \tilde{ϕ}ᵢ 352 is provided as an anchor policy for the next iterative training round. The updated data augmentation policy may alternatively or additionally be output at 352, e.g., for storing, for training the neural network model during the evaluation phase 104, etc.

FIG. 4 shows an algorithm 400 for implementing an example method. The augmentation policy parameter ϕ is initialized (line 1), e.g., to provide an initial augmentation policy, and the neural network is pretrained (line 2) using the initial augmentation policy to provide an initial, pretrained neural network model θ₀.

To improve or ensure the stability of the parameter updates during each training round, example bilevel optimization methods employ a cold-start approach (line 4) for the neural network model (e.g., prediction model) and an anchoring approach (line 5) for the data augmentation model. The cold-start strategy structures the learning into training rounds n_{rounds} which share the current, e.g., most recently updated, augmentation policy ϕ but restart the neural network from the pretrained one (the initial, pretrained neural network model). An example cold-start approach initializes the neural network model at the beginning of each training round using the initial pretrained neural network model θ₀.

An example anchoring approach further enhances the data augmentation policy search, e.g., using a divergence or entropy regularization such as but not limited to a KL regularization. An example anchoring approach encourages the current data augmentation policy to remain close to some anchor policy p_{\tilde{ϕ}}. \tilde{ϕ} is set to the current augmentation policy parameter ϕ at the beginning of each training round (line 5).

During the lower-level (inner loop) training over a first plurality of steps, e.g., the first nᵣₑₜᵣₐᵢₙ steps (line 6), of each training round, the example method updates the model parameter θ using a stochastic estimate [symbol] of V_{θ} [symbol] ₜᵣₐᵢₙ(θ,ϕ) (lines 7-8) while maintaining the data augmentation policy fixed. Then, for an additional plurality of steps, e.g., for the last nₜₒₜₐₗ−nᵣₑₜᵣₐᵢₙ steps (line 9), the example method alternates between prediction model updates (lines 7-8) and augmentation policy updates (lines 10-11).

The data augmentation policy updates aim to minimize the sum of the upper-level objective [symbol] and an anchoring divergence or entropy d(p_{ϕ},p_{\tilde{ϕ}}):=KL(p_{π},p_{\tilde{π}}) encouraging the augmentation policy p_{ϕ} to remain close to the anchor policy p_{\tilde{ϕ}}. These updates can be obtained using a stochastic estimate [symbol] along with the exact gradient of the KL regularization, which admits a closed-form expression.

Gradient estimation: Estimating the gradient of [symbol] (ϕ) [symbol] and [symbol] can consider the complex dependence of the upper-level loss on the policy p_{ϕ} through the optimal model parameter θ*(ϕ) learned using such a policy. Example methods approximate the optimal model parameter θ*(ϕ) with a simpler function \hat{θ}(ϕ) that is easier to compute:

$$\hat{θ} ( ϕ ) := θ - η {∇}_{θ} {ℒ}_{t r a i n} ( θ , ϕ ) \qquad ( 4 )$$

Equation (4) corresponds to one gradient step to optimize the lower-level loss starting from the current parameter θ and ϕ using step-size η>0. By keeping track of the dependence in ϕ and exploiting the fact that the augmentation policy p_{ϕ} has a score ∇_{ϕ} log p_{ϕ}(τ) that can be computed explicitly using Equation (1), example methods can use the REINFORCE/Score method, such as disclosed in Michael C Fu, Gradient estimation. Handbooks in operations research and management science, 13:575-616, 2006, to derive a closed-form expression for ∇_{ϕ}\hat{θ}(ϕ), which can serve for approximating the gradient of [symbol] :

$${∇}_{ϕ} \hat{θ} ( ϕ ) = - {η𝔼}_{τ ∼ {p}_{ϕ}} [ {∇}_{θ} {ℓ}_{t r a i n} ( θ , τ ) {∇}_{ϕ} log {{p}_{ϕ} ( τ )}^{T} ] .$$

Then, the upper-level loss [symbol] (ϕ) can be approximated with a simpler function [symbol] (ϕ):= [symbol] ᵥₐₗ(\hat{θ}(ϕ) and the gradient ∇_{ϕ} [symbol] (ϕ) with ∇_{ϕ} [symbol] (ϕ), which can be obtained using the chain rule:

$${∇}_{ϕ} ℱ ( ϕ ) \approx {∇}_{ϕ} \hat{ℱ} ( ϕ ) = {∇}_{θ} {{ℒ}_{val} ( \hat{θ} ( ϕ ) )}^{T} {∇}_{ϕ} \hat{θ} ( ϕ ) . \qquad ( 5 )$$

The above expression requires only first-order derivatives and matrix-vector products, which is amenable to efficient implementation using automatic differentiation software and/or hardware.

Stochastic gradient estimates: In an example method, all expectations can be replaced by estimates on a batch of data and sampled augmentations. More precisely, to compute the approximation [symbol] to ∇_{θ} [symbol] ₜᵣₐᵢₙ(θ,ϕ), an example method samples B_{aug} augmentations from p_{ϕ} and then applies each of them to a batch of training data Bₜᵣₐᵢₙ from [symbol] ₜᵣₐᵢₙ. Using the same batch of data and augmentation, the example method approximates \hat{θ}(ϕ) and ∇_{ϕ}\hat{θ}(ϕ) in Equation (5). Further, a batch Bᵥₐₗ of data from [symbol] ᵥₐₗ is used to estimate ∇_{θ} [symbol] ᵥₐₗ(\hat{θ}(ϕ) and compute [symbol] , which is a stochastic estimate of ∇_{ϕ} [symbol] (ϕ) in Equation (5).

An embodiment of the gradient estimates will now be described for purposes of illustrating example features. To optimize the augmentation policies, an example method minimizes an approximation to the upper-level objective [symbol] (ϕ):= [symbol] ᵥₐₗ(θ*(ϕ)) defined as [symbol] (ϕ):= [symbol] ᵥₐₗ(\hat{θ}(ϕ), where the (e.g., intractable) lower-level solution θ*(ϕ) is replaced by an approximate solution \hat{θ} (ϕ). Such an approximate solution can be obtained by performing one gradient step to optimize the lower-level objective starting from the current parameter θ, i.e., \hat{θ}(ϕ):=θ−η∇_{θ} [symbol] ₜᵣₐᵢₙ(θ,ϕ). The gradient ∇_{ϕ} [symbol] is then naturally approximated by ∇_{ϕ} [symbol] , which is computed by applying the chain rule:

$${∇}_{ϕ} ℱ \approx {∇}_{ϕ} \hat{ℱ} = {∇}_{θ} {{ℒ}_{val} ( \hat{θ} ( ϕ ) )}^{T} {∇}_{ϕ} \hat{θ} ( ϕ ) .$$

The Jacobian ∇_{ϕ} [symbol] can be computed explicitly using the Score method, which yields:

$${∇}_{ϕ} \hat{θ} ( ϕ ) = - {η𝔼}_{τ ∼ {p}_{ϕ}} [ {∇}_{θ} {ℓ}_{t r a i n} ( θ , τ ) {∇}_{ϕ} log {{p}_{ϕ} ( τ )}^{T} ]$$

In an example operation, expectations over the data and augmentations policies can be estimated with batches. At a given iteration, B_{aug} augmentations are sampled from p_{ϕ} and then each of them is applied to a batch of training data Bₜᵣₐᵢₙ from [symbol] ₜᵣₐᵢₙ to approximate ∇_{ϕ}\hat{θ}(ϕ). A batch [symbol] ᵥₐₗ of data from [symbol] ᵥₐₗ is also used to estimate the validation loss. Denoting Nₐ, Nₜ, Nᵥ the size of the augmentation, training, and validation batches respectively, and

$$( θ ) : = \frac{1}{{N}_{v}} {\sum }_{( x , y ) ∈ {B}_{val}} [ ℓ ( y , {f}_{θ} ( x ) ) ] , ( θ , τ ) : = \frac{1}{{N}_{t}} {\sum }_{( x , y ) ∈ {B}_{train}} [ ℓ ( y , {f}_{θ} ( τ ( x ) ) ) ] ,$$

and the gradient estimate can be expressed as

$${∇}_{ϕ} ℱ \approx - \frac{η}{{N}_{a}} {∇}_{\hat{θ}} {\hat{l}}_{val} ( θ ) ( {\sum }_{τ ∈ {B}_{aug}} {∇}_{θ} {\hat{l}}_{t r a i n} ( θ , τ ) {∇}_{ϕ} log {{p}_{ϕ} ( τ )}^{T} ) = - \frac{η}{{N}_{a}} {\sum }_{τ ∈ {B}_{aug}} {∇}_{θ} {{\hat{l}}_{val} ( θ )}^{T} {∇}_{θ} {\hat{l}}_{t r a i n} ( θ , τ ) {∇}_{ϕ} log {p}_{ϕ} ( τ ) .$$

Put another way, the upper-level gradient in embodiments is a weighted sum of the scores ∇_{ϕ} log p_{ϕ}(τ), with the weights representing the alignment between the gradients of (i) the loss on the training data transformed with τ (evaluated at θ), and (ii) the loss on the validation data (evaluated at \hat{θ}, that is, one step ahead).

In operation, the lower-level learning rate decreases with a cosine schedule. To avoid shrinking of the upper-level gradient updates, η can be set to the initial value of the lower-level learning rate instead of its current value.

Cold-start: An example cold-start strategy (e.g., FIG. 4, lines 4, 7, and 8) allows retraining of the neural network model at each training round with the current data augmentation policy starting from the initial (pretrained) neural network model. This approach is closer to a bilevel formulation that implies finding an optimal prediction model for each policy. Initializing with a pretrained model yields computational gain, as fewer iterations are needed to optimize the neural network model. In other example embodiments, a warm-start approach may be used that initializes the neural network model at each training round with the learned model at the previous training round, though this approach may lead to overfitting and less optimal quality of the learned policies.

Anchoring using KL regularization: Adding an anchoring divergence or entropy d(p_{ϕ},p_{\tilde{λ}}):=KL(p_{π},p_{\tilde{π}}) with a strength parameter λ when updating the policy (line 5 of FIG. 4) can prevent an example training method from collapsing towards trivial policies. This anchoring affects only the categorical distribution p_{π}. For the magnitudes p_{μ}, anchoring may be omitted, e.g., for instance if a uniform distribution is used, as such anchoring may be ill-defined. Instead, smaller step-sizes may be used.

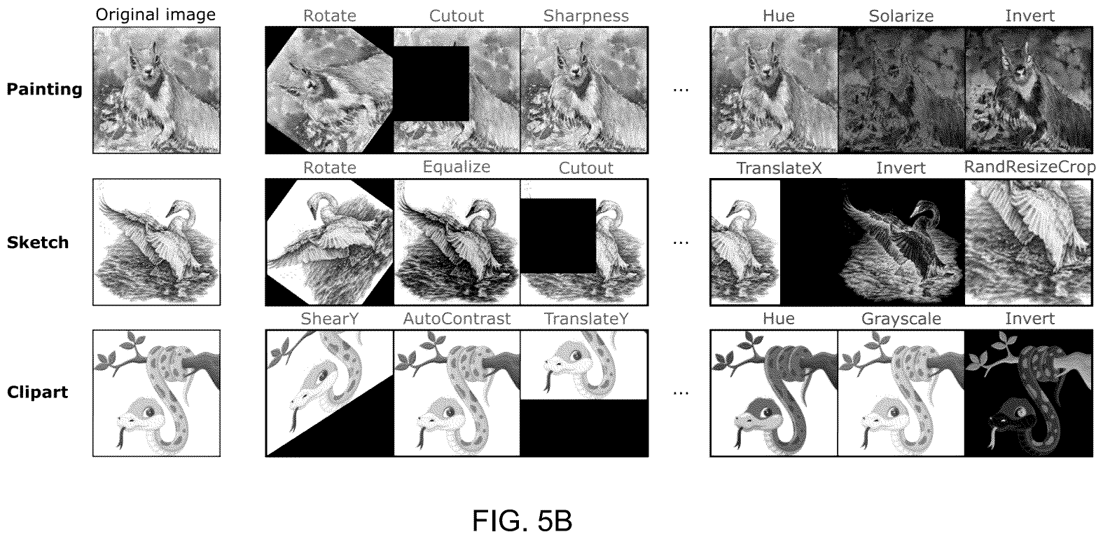

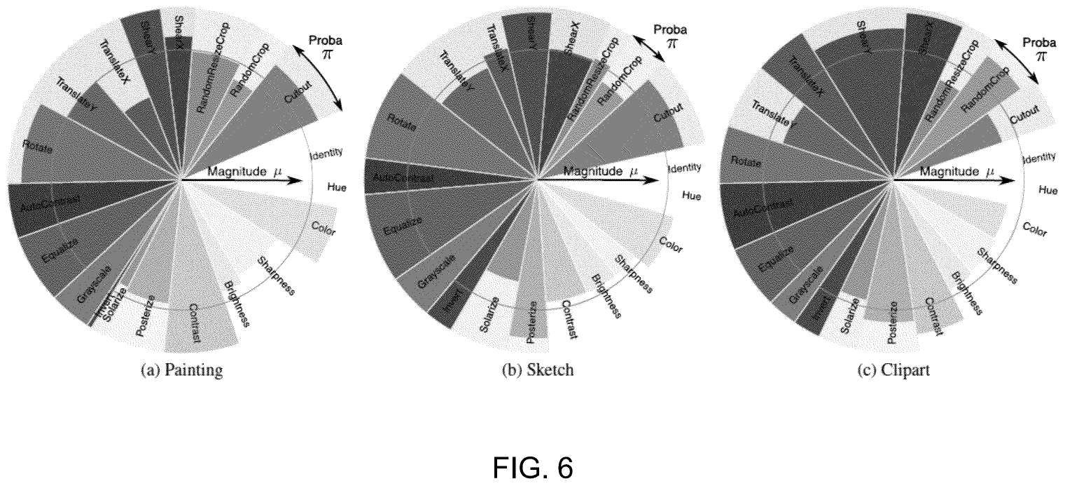

Training neural network model with augmented data: FIG. 5A shows a method 500 for training a neural network model on a task using a trained data augmentation policy. The method 500 may be, but need not be, an example of the evaluation phase 104, or a separate training method. Augmented data is generated from a data distribution at 502, using the trained data augmentation policy. The neural network can be retrained at 504, or another neural network can be trained, using the augmented data. The data distribution from which the augmented data is generated in step 502 may be or may be taken from the same or a different dataset (e.g., training set [symbol] ) than the dataset from which training and evaluation datasets are split for training the prior neural network and/or the augmentation policy. For instance, the dataset that is augmented at 502 and used to train or retrain the neural network at 504 may have the same or different context or be from a same or different domain as that used to learn the data augmentation policy.

The trained neural network model may further be tested, e.g., evaluated, at 508 using a testing dataset, without augmentation, such as a test set, e.g., [symbol] ₜₑₛₜ, which may be a separate dataset from the training set or evaluation set, or separate from the training set [symbol] , and may have the same or different context or be from a same or different domain or larger data distribution. After training or retraining, and before or after testing at 508, updated parameters of the trained neural network model may be stored at 506.

The trained neural network model may optionally be used for inference on a new input at 510. For instance, for a neural network model trained on an image classification task, the trained neural network model may receive one or more new images from any suitable image source and perform a classification task. The trained neural network model may be used for performing a task, e.g., image classification, or a different task, and may be further trained, fine-tuned, adapted, and/or combined with upstream or downstream tasks in a network or model. The result of the neural network task (such as but not limited to an image classification) may be stored, output for one or more downstream tasks, provided for display on a display, etc.

### Experiments

An approach used in experiments herein addressed the bilevel optimization problem using the REINFORCE gradient estimator. These example methods can be prior-free (that is, do not or need not rely on default transformations) and can use a full training set while maintaining a reasonable search time (e.g., in GPU hours).

Setup: An experimental model according to example embodiments was evaluated on three standard benchmarks: CIFAR10, CIFAR100, and ImageNet-100,which are all composed of natural images. To assess how an example training method generalizes beyond the domain of natural images, the model was evaluated on the DomainNet dataset, which contains 345 classes for 6 different domains. To ensure the example protocol used a similar number of training images for each domain, a reduced set of 50,000 training images was used for the two largest domains (real, quickdraw) and the remaining images were left for testing. For the other domains, 20% of the data was isolated for testing.

Architectures: CIFAR10/100 was evaluated with two architectures that are standards for automatic data augmentation: WideResNet-40x2 and WideResNet-28x10. The experiments searched and evaluated using the same architecture. ImageNet-100 and DomainNet were evaluated with a ResNet-18 architecture.

Transformation space: The data augmentation search space was composed of a standard pool of 15 transformations: Identity, ShearX, ShearY, TranslateX, TranslateY, Rotate, AutoContrast, Equalize, Invert, Solarize, Posterize, Contrast, Brightness, Sharpness, and Color. This pool was supplemented with transformations that previous methods have usually applied by default, namely Cutout and RandomCrop for CIFAR, RandomResizeCrop for ImageNet, and Grayscale for DomainNet. Following previously disclosed methods, when RandomResizeCrop was sampled, it was always applied first, and the range of its scale parameter was learned. ColorJitter, also typically applied by default for ImageNet, was not added, as it was already a mix of Brightness, Contrast, and Color. However, Hue was added, which is a component of ColorJitter never applied by default.

Magnitude ranges: Ranges used for mapping the magnitudes to [0,1] can vary across methods. Table 1 indicates an example mapping for each experimental method. For transformations with respect to which the datasets naturally exhibit symmetries (such as Shear, Translate, Rotate, Enhance), an example method randomly selects a direction once a magnitude is sampled. The ranges for example methods can be larger than conventional ranges (such as those in TA (RA)), which provides more flexibility during the optimization of the magnitude upper-bounds μ. In an example, the latter is initialized at 0.75. This initialization can be high enough to favor exploration and avoid over-fitting during pretraining. In experiments, initializations in the [0.75, 0.9] range consistently worked well across datasets, though other ranges could be used. TrivialAugment uses [−0.31, 0.31], and sets the upper-bounds in pixels, not in proportion. *** indicates Color, Contrast, Brightness, and Sharpness, and **** indicates Color, Contrast, and Brightness.

TABLE 1

| | | Method | | | |
|---|---|---|---|---|---|
| Application | Transformation | TA (RA) | TA (Wide) | DomainBed | Ours |
| Sampled | ShearX/Y | [0, 0.3] | [0, 0.99] | — | [0, 1] |
| | Translate X/Y | [0, 0.45]* | [0, 32px]** | — | [0, 0.75] |
| | Rotate | [0, 30] | [0, 135] | — | [0, 90] |
| | Posterize | [4, 8] | [2, 8] | — | [2, 8] |
| | Solarize | [0, 255] | [0, 255] | — | [0, 255] |
| | Enhance*** | [0, 0.9] | [0, 0.99] | — | [0, 0.99] |
| | Cutout | [0, 0.2] | [0, 0.6] | — | [0, 1] |
| | RandCrop | — | — | — | [0, 0.5] |
| Default | ColorJitter**** | [0, 0.4] | [0, 0.4] | [0, 0.3] | — |
| ImageNet/DomainNet | RandResizeCrop | [0.08, 1] | [0.08, 1] | [0.7, 1] | — |
| | Cutout | 0.5 | 0.5 | NA | — |
| | RandCrop | 0.125 | 0.125 | NA | — |

Magnitudes for Cutout and RandomCrop were also uniformly sampled, as opposed to being hand-selected. Since the datasets were horizontally symmetric, flip was applied by default.

Image preprocessing: Table 2 indicates example preprocessing choices on ImageNet-100 and DomainNet for TrivialAugment, DomainBed, and SLACK. ImageNet-100 and DomainNet images have variable original sizes. In prior disclosures, training images are commonly resized with RandomResizeCrop. For testing, TrivialAugment uses Resize (256)+CenterCrop ((224,224)), preserving the aspect ratio, while DomainBed directly applies Resize ((224,224)), degrading the aspect ratio but preserving the image content. In experiments, the choices made in the disclosures are used, and it was observed that they respectively yielded the best results.

TABLE 2

| Dataset | Model | Train | Test |
|---|---|---|---|
| Imape Net-100 | TrivialAugment | Rand/ResizeCrop(224.224)) | Resize(256) + CenterCrop(224, 224) |
| | SLACK | Resize(256) + | Resize(256) + CenterCrop |
| | | RandomCrop((224, 224)) | (224, 224) |
| DomainNet | TrivialAugment | RandResizeCrop(224.224) | Resize(256) + |
| | ImageNet | | CenterCrop(224.224) |
| | TrivialAugment | Resize(256) + RandomCrop | Resize(256) + |
| | CIFAR | (224, 224), padling = 28) | CenterCrop(224, 224) |
| | DomainBed | Rand(ResizeCrop(224.224)) | Resize(224.224) |
| | SLACK | Resize((224.224)) | Resize ((224.224)) |
| | (Clipart, | | |
| | Sketch, | | |
| | Quickdraw) | | |
| | SLACK | Resize(256) + | Resize(256) + |
| | (Painting, | RandomCrop(224.224)) | CenterCrop(224, 224)) |
| | Infograph, | | |
| | Real) | | |

For SLACK, which does not apply RandomResizeCrop by default, the training data and the validation/testing data were preprocessed in the same way. For training, random cropping was applied instead of center cropping to fully exploit the data. For ImageNet-100, TrivialAugment's preprocessing was used. For DomainNet, the preprocessing strategy was selected by cross-validation after pretraining.

Policy search: A training/validation (train/val) split of 0.5/0.5 was applied, meaning that half of the data was used to train the classification model parameters and the other half was used to learn the augmentation policy. Pretraining was performed in the same setting as the evaluation, except that the experiments trained only with the train data in the train/val split of the search phase. SGD (Stochastic Gradient Descent) with momentum was used for the optimization of the validation and training losses. For the training losses, the same weight decay was used as for the final policy evaluation. Eight different augmentations were sampled for computing the expectation that was needed for the stochastic gradient estimate.

Hyperparameters used for policy search in the experiments are indicated in Table 3. These are chosen to satisfy two criteria that can be useful in policy search: (i) the validation loss after retraining should be similar (experimentally, slightly lower) to the one obtained after pretraining, and (ii) the probability distributions should vary at the same speed for all datasets. The example learning rate was four times larger for retraining on CIFAR10 than on CIFAR100. It was observed that gradients on CIFAR10 were four times smaller in norm than those on CIFAR100, and that rescaling the updates allowed satisfying the above two criteria empirically.

TABLE 3

| | | | | | | | KL. |
|---|---|---|---|---|---|---|---|
| | | Re-train | Unrolled | Batch | Lower | Upper | weight × |
| Dataset | Network | iter | iter | sine | lr | lr | Upper lr |
| CIFAR | WRN-40- | 1000 | 400 | 8 × 128 | 0.4/ | 1 | 0.02 |
| 10/100 | 2JWRN-28-10 | | | | 0.1 | | |
| Image Net- | ResNet-18 | 2000 | 800 | 8 × 256 | 0.1 | 0.5 | 0.005 |
| 100 | | | | | | | |
| DomainNet | ResNet-18 | 800- | 400 | 8 × 128 | 0.1 | 0.625- | 0.01 |
| | | 1200 | | | | 1.25 | |

For DomainNet, the number of retraining steps was adapted to the dataset size. A fixed lower-level learning rate for all datasets experimentally satisfied criterion (i). It was observed that the lower-level gradients differed in scale for each dataset. To satisfy criterion (ii), the example method rescaled the KL regularization and accordingly changed the upper-level learning rate, so that KL weight×upper level learning rate was constant.

The upper-level learning rate indicated in the Tables was the one used for updating π. It was divided by 40 for the optimization of μ to ensure slower updates for the magnitude parameter, as it was sensitive to variations (or by 10 for ablations removing the KL regularization).

Policy evaluation: The models were evaluated following the framework of TrivialAugment, as disclosed in Samuel G. Muller and Frank Hutter. TrivialAugment: tuning-free yet state-of-the-art data augmentation. In Proc. ICCV, 2021. The hyperparameters used for the evaluation phase are indicated in Table 4. For CIFAR10 and CIFAR100, the experiments used the same hyperparameters as in earlier work.

TABLE 4

| | | | Batch | Learning | Weight |
|---|---|---|---|---|---|
| Dataset | Network | Epochs | size | rate | decay |
| CIFAR10/100 | WRN-40-2, | 200 | 128 | 0.1 | 0.0005* |
| | WRN-28 × 10 | | | | |
| Image Net-100 | ResNet-18 | 270 | 256 | 0.1 | 0.001 |
| DomainNet | ResNet-18 | 200 | 128 | 0.1 | 0.001 |

Each policy was evaluated with four independent runs, meaning that the results were averaged over a total of 4×4=16 evaluations. Some comparative experiments augmented images using a uniform augmentation policy, corresponding to the example data augmentation policy initialization described above, in which the data augmentation policy uniformly sampled over all image transformations, corresponding to an identical probability to select any transformation (referred to below as Uniform augmentation policy or Uniform policy), and the results on TrivialAugment were evaluated with eight independent runs. A confidence interval was provided that contains the true mean with probability p=95%, under the assumption of normally distributed accuracies.

Example methods were compared with the Uniform augmentation policy as well as several previous approaches for data augmentation, including AutoAugment (AA), Fast AutoAugment (FastAA), Differentiable Automatic Data Augmentation (DADA), RandAugment (RA), Teach Augment, UniformAugment, TrivialAugment (TA), and Deep AutoAugment (DeepAA). For each method, the total number of composed transformations and the number of hard-coded transformations among these, were indicated, as shown in Tables 5 and 6. For present example methods, an example embodiment of which is referred to in the tables as SLACK, the policies obtained from four independent search runs were evaluated, each with four different train/val splits, to assess robustness. The same process was followed when reproducing DeepAA on CIFAR10/100. All previous methods used a single run for search, before evaluating the policy with one or multiple runs. 95% confidence intervals were reported for those evaluated with multiple runs.

Table 5 shows test accuracies on CIFAR10 and CIFAR100. For SLACK and DeepAA (reproduced), four independent searches were conducted, and each policy was evaluated with four evaluation runs, resulting in averages over 16 evaluations. TA and DeepAA were also evaluated with multiple evaluation runs. Results for the remaining methods were reported from the corresponding papers and based on a single run. DeepAA uses hard-coded transformations for pretraining, and learns random flipping, unlike other baselines.

TABLE 5

| | # Augmentations | | | | | |
|---|---|---|---|---|---|---|
| | | Hard- | CIFAR 10 | | CIFAR100 | |
| | Total | coded | WRN-40-2 | WRN-28-10 | WRN-40-2 | WRN-28-10 |
| AA [2] | 4 | 2 | 96.3 | 97.4 | 79.3 | 82.9 |
| FastAA [15] | 4 | 2 | 96.4 | 97.3 | 79.4 | 82.7 |
| DADA [14] | 4 | 2 | 96.4 | 97.3 | 79.1 | 82.5 |
| RA [3] | 4 | 2 | — | 97.3 | — | 83.3 |
| TeachA [24] | 4 | 2 | — | 97.5 | — | 83.2 |
| UniformAugment | 4 | 2 | 96.25 | 97.33 | 79.01 | 82.82 |
| [17] | | | | | | |
| TA (Wide) [19] | 3 | 2 | 96.32 ± .05 | 97.46 ± .06 | 79.86 ± .19 | 84.33 ± .17 |
| Uniform policy | 3 | 0 | 96.12 ± .08 | 97.26 ± .07 | 78.79 ± .25 | 82.82 ± .24 |
| DeepAA [31] | 6* | 0* | — | 97.56 ± .14 | — | 84.02 ± .18 |
| DeepAA | 6** | 0* | 96.25 ± .11 | 97.27 ± .11 | 79.26 ± .35 | 83.38 ± .33 |
| (reproduced) ^{†} | | | | | | |
| SLACK (Ours) | 3 | 0 | 96.29 ± .08 | 97.46 ± .06 | 79.87 ± .11 | 84.08 ± .16 |

CIFAR: As shown in Table 5, example training methods (SLACK) were competitive on both CIFAR10 and CIFAR100, despite not hard-coding Cutout and RandomCrop in the example augmentation policy. Cutout and Rotate were selected with a high probability, while the Invert transformation was systematically discarded. This result was consistent with the choices made in practice by prior methods that added/removed these transformations manually. A mismatch was observed between DeepAA's reported results and those obtained by experiments when evaluating their approach on multiple search runs, which was likely due to the stochasticity of the search procedure.

FIG. 5B illustrates example transformations for an experimental operation of the example SLACK training method that were found to be most important/detrimental on a dataset of different domains, including non-natural images. In FIG. 5B, for different domains of the DomainNet dataset (one per line), an image is shown from that domain (left) and that image transformed using the three most likely (middle) and three least likely (right) augmentations for that domain, as estimated by the SLACK training method.

ImageNet-100: Results (test accuracies) for ImageNet-100 are shown in Table 6.

TABLE 6

| | # Augmentations | | ImageNet-100 |
|---|---|---|---|
| | Total | Hard-coded | ResNet18 |
| TA (RA) [19] ^{†} | 5 | 4 | 85.87 ± .30 |
| TA (Wide) [19] ^{†} | 5 | 4 | 86.39 ± .18 |
| Uniform policy | 3 | 0 | 85.78 ± .32 |
| SLACK | 3 | 0 | 86.06 ± .11 |

SLACK (example method) was compared to the Uniform policy and to TrivialAugment (RA) and (Wide) variants, the latter using larger magnitude ranges for its random transformation. SLACK's results were between both variants, and they were improved over the Uniform policy. For ImageNet-100, it was found that RandomResizeCorp was not favored during the search phase, suggesting that it was not critical for ImageNet-100. Instead, the performance gap between TA (Wide) and TA (RA) suggested that harder transformations were key to a better performance for this dataset.

Generalization to other domains: For the DomainNet dataset, SLACK was compared to a Uniform augmentation policy as described above, to the augmentations used by DomainBed for domain generalization, and to the TrivialAugment (RA) and (Wide) methods with their ImageNet and CIFAR default settings. Results are shown in Table 7.

TABLE 7

| | # Augmentations | | | | | | | | |
|---|---|---|---|---|---|---|---|---|---|
| | | Hard- | | Quickdraw- | | | | | |
| | Total | coded | Real-50k | 50k | Inforgraph | Sketch | Painting | Clipart | Average |
| DomainBed ^{†} | 5 | 5 | 62.54 +− .15 | 66.54 +− .91 | 26.76 +− .36 | 59.54 +− .37 | 58.31 +− .25 | 66.23 +− .10 | 57.23 +− .18 |
| TA (RA) | 5 | 4 | 70.85 +− .13 | 67.85 +− .07 | 35.24 +− .19 | 65.63 +− .11 | 64.75 +− .18 | 70.29 +− .18 | 62.43 +− .05 |
| ImageNet ^{†} | | | | | | | | | |
| TA (Wide) | 5 | 4 | 71.56 +− .07 | 68.60 +− .05 | 35.44 +− .33 | 66.21 +− .16 | 65.15 +− .20 | 71.19 +− .19 | 63.03 +− .07 |
| ImageNet ^{†} | | | | | | | | | |
| TA (RA) | 3 | 2 | 70.28 +− .08 | 68.35 +− .07 | 33.85 +− .21 | 64.13 +− .12 | 64.73 +− .17 | 70.33 +− .21 | 61.94 +− .05 |
| CIFAR ^{†} | | | | | | | | | |
| TA (Wide) | 3 | 2 | 71.12 +− .10 | 69.29 +− .05 | 34.21 +− .29 | 65.52 +− .25 | 64.81 +− .14 | 71.01 +− .21 | 6266 +− .07 |
| CIFAR ^{†} | | | | | | | | | |
| Uniform policy | 3 | 0 | 70.37 +− .08 | 68.27 +− .06 | 34.11 +− .21 | 65.22 +− .17 | 63.97 +− .24 | 72.26 +− .14 | 62.37 +− .06 |
| SLACK (ours) | 3 | 0 | 71.00 +− .13 | 68.14 +− .11 | 34.78 +− .18 | 65.41 +− .16 | 64.83 +− .12 | 72.65 +− .20 | 62.80 +− .06 |

DomainBed uses the same default transformations as TA ImageNet together with Grayscale, but with smaller magnitudes, and unlike TA it does not add a random transformation. Yet, DomainBed strongly overfit and performed much lower than TA. This suggests that augmentations well suited for domain generalization did not perform well on the individual tasks. TA (Wide) ImageNet consistently outperformed all other TA variations. This further suggests benefits in example methods of learning the magnitude range as opposed to employing a manual range selection process.

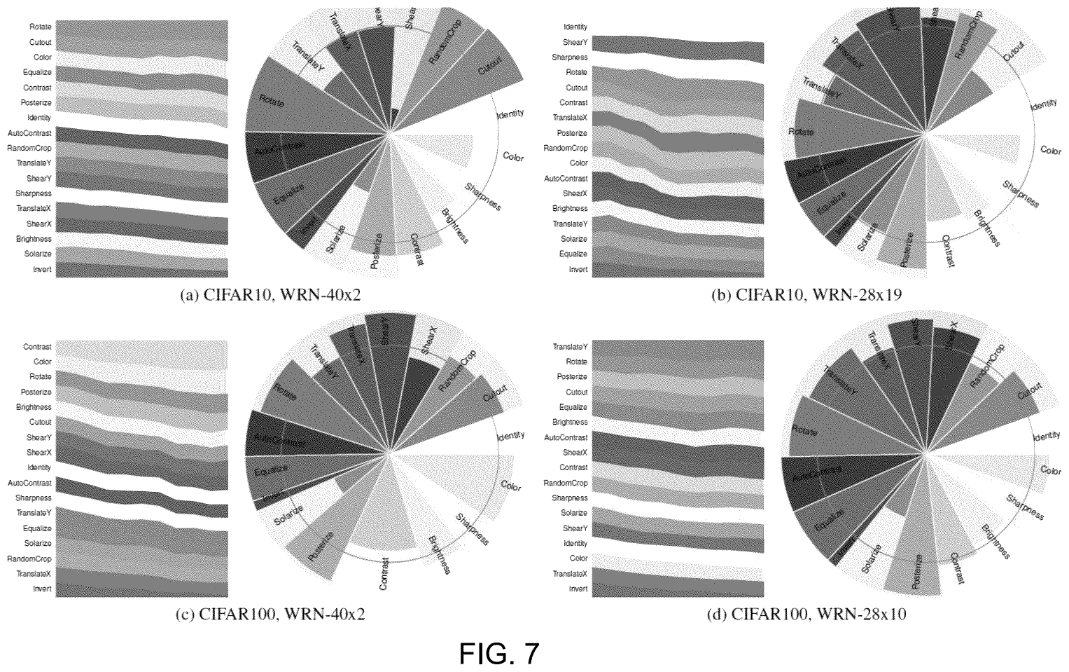

SLACK was a close second, even though it learned the augmentation policy end-to-end. FIG. 6 shows the learned policies found on DomainNet for the best search split as pie charts. Transformations which were parameter-free, namely AutoContrast, Equalize, Grayscale, and Invert, are shown with maximal magnitude upper-bound.

The slices represent the probability It over the different transformations while their radius represents corresponding magnitudes. They differ from one domain to another, suggesting that the gain compared to the initialization (i.e., Uniform policy) results from SLACK's ability to learn and adapt to each domain.

Features of example systems and methods, including the network architecture used for search, the regularization, and the augmentation policy parameters π and μ, were compared in additional, ablation experiments. Hyperparameters were adjusted to each baseline included in comparisons to make them as competitive as possible.

Impact of Network architecture for search: In some prior methods, the search phase (if there is one) was conducted on the smaller WideResNet-40x2 architecture for CIFAR10 and CIFAR100, and the learned policy was evaluated for both WideResNet-40x2 and WideResNet-28x10. Table 8 shows CIFAR10/100 accuracy evaluated with WRN-28-10, showing an impact of using a smaller architecture for the search phase. The Table shows that for an example SLACK implementation, searching directly with WideResNet-28x10 provided the best results for that architecture.

TABLE 8

| Search architecture | CIFAR10 | CIFAR100 |
|---|---|---|
| WRN-40-2 | 97.43 ± .04 | 83.94 ± .20 |
| WRN-28-10 (ours) | 97.46 ± .06 | 84.08 ± .16 |

Impact of Regularization: SLACK was compared with a variant that does not apply KL-regularization. For the latter, the outer learning rate was reduced so that the augmentation policies with and without regularization evolved at similar speeds. Table 9 shows CIFAR10/100 accuracy with and without KL regularization. The results shown in Table 9 indicate that KL-regularization was beneficial.

TABLE 9

| | CIFAR10 | | CIFAR100 | |
|---|---|---|---|---|
| SLACK variant | WRN-40-2 | WRN-28-10 | WRN-40-2 | WRN-28-10 |
| without KL | 96.27 ± .05 | 97.06 ± .11 | 79.61 ± .13 | 83.79 ± .19 |
| with KL. (ours) | 96.29 ± .08 | 97.46 ± .06 | 79.87 ± .11 | 84.08 ± .16 |

Joint learning of π and μ: Table 10 illustrates benefits of jointly learning augmentation parameters, as compared to the initial Uniform augmentation policy and to a setting where only π or μ is learned. Table 10 shows CIFAR10/100 accuracy when only learning part of the policy parameters.

TABLE 10

| | CIFAR10 | | CIFAR100 | |
|---|---|---|---|---|
| SLACK variant | WRN-40-2 | WRN-28-10 | WRN-40-2 | WRN-28-10 |
| Uniform | 96.22 ± .10 | 97.38 ± .05 | 79.07 ± .24 | 83.26 ± .17 |
| policy | | | | |
| μ only | 96.20 ± .08 | 97.42 ± .05 | 79.22 ± .17 | 83.57 ± .18 |
| π only | 96.22 ± .09 | 97.35 ± .04 | 79.36 ± .11 | 83.45 ± .15 |
| π and μ (ours) | 96.29 ± .08 | 97.46 ± .06 | 79.87 ± .11 | 84.08 ± .16 |

Considering the more challenging bilevel optimization problem that arises when the search space is not reduced with default transformations, example methods herein were demonstrated to address the stability issues that may arise by providing a multi-stage approach based on cold-start coupled with a divergence regularization. These features allow example methods to reduce the variance of the gradient estimate and to better control the optimization process. Example methods can perform comparably to other approaches that rely on prior knowledge. Further, example methods are versatile enough to select domain-specific transformations even with being confronted with non-natural images.

Example training methods using regularized multi-stage training approaches improved the stability of the bilevel optimization algorithm use for solving the data augmentation learning problem. Further, example systems and methods provide a simple and interpretable model of the policies that allows learning both frequency and magnitude of the data augmentations. Experimental operations of example methods on challenging experimental settings demonstrate that such methods provide competitive augmentation strategies on natural images even without resorting to prior information, and that such methods generalize to other domains.

Uniform magnitude distribution: The experiments demonstrated that using a uniform magnitude distribution globally outperformed optimized magnitude models in earlier disclosed methods. This was shown by directly evaluating the policies provided in disclosures without re-running their search procedure. Their learned magnitude model was compared to a simpler one provided by sampling the magnitudes uniformly on their [0,1]-mapped ranges. Three baselines were considered: DADA, FastAA, and DeepAA. Their policy results from a search on CIFAR10, that they also use when evaluating on CIFAR100. Results are shown in Table 11.

TABLE 11

| | | CIFAR10 | | CIFAR 100 | |
|---|---|---|---|---|---|
| Model | Magnitude model | WRN-40-2 | WRN-28-10 | WRN-40-2 | WRN-28-10 |
| FastAA/DADA initialization | Theirs | 96.22 | 97.08 | 78.26 | 82.17 |
| | Uniform | 96.37 | 97.25 | 79.10 | 82.80 |
| FastAA, reported | Original | 96.4 | 97.3 | 79.3 | 82.7 |
| FastAA, reproduced | Original | 96.4 | 97.22 | 79.11 | 82.82 |
| (evaluation only) | Uniform | 96.37 | 97.30 | 79.15 | 82.84 |
| DADA, reported | Original | 96.4 | 97.3 | 79.1 | 82.5 |
| DADA, reproduced | Original | 96.33 | 97.19 | 79.07 | 82.05 |
| (evaluation only) | Uniform | 96.37 | 97.35 | 78.97 | 82.57 |
| DeepAA, reported | Original | — | 97.56 | — | 84.02 |
| DeepAA, reproduced | Original | 96.46 | 97.48 | 79.62 | 83.85 |
| (evaluation only) | Uniform | 96.55 | 97.47 | 78.89 | 83.62 |

Parametrization: DADA and FastAA directly optimize a probability distribution over the set of all possible composite transformations (or sub-policies) and learn a single magnitude value for each transformation in a sub-policy. They keep the top-k sub-policies for evaluation. DeepAA learns to compose transformations in a greedy manner and discretizes the magnitude ranges, learning a probability for each magnitude. These learned magnitude values (FastAA, DADA) or learned probabilities were compared to an example inventive approach based on a uniform sampling.

The approach according to example methods compared favorably to DADA's and FastAA's optimized models. Both approaches were also compared on their initial policy (equal probabilities for all sub-policies, magnitudes set at mid-range). With uniform magnitude sampling, their initial policy (sampling among all possible sub-policies) performed similarly if not better than their optimized one (sampling among their top-k sub-policies). For DeepAA, using uniform sampling improved results on CIFAR10 (on which their search was conducted) and degraded them on CIFAR100.

### Visualization of the Learned Policies

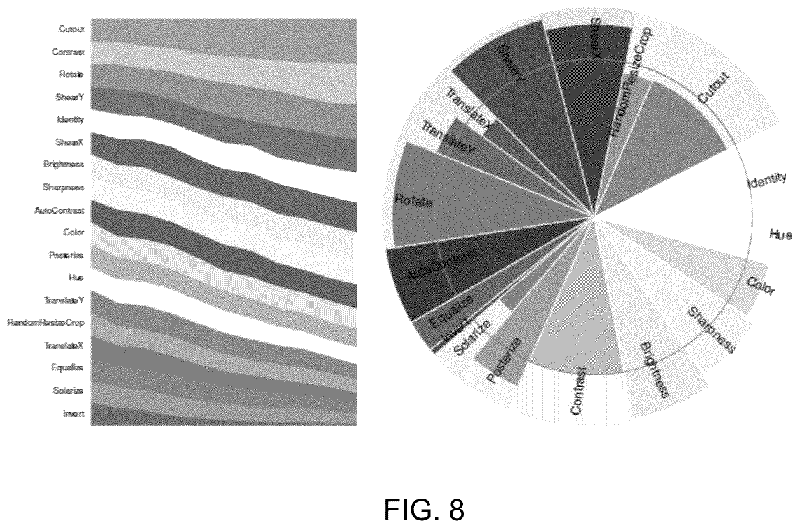

CIFAR: The evolution of probability distributions for CIFAR10 and CIFAR100 and pie charts of the final policies are illustrated in FIG. 7. Invert and Solarize, known to be detrimental, were systematically discarded. The policies learned were quite diverse, with different leading transformations for each distribution but global predominance of some transformations such as Cutout or Rotate. Magnitudes upper-bounds were on average higher for the larger WideResNet-28x10 networks, indicating that a larger learning capacity benefits more from harder transformations.

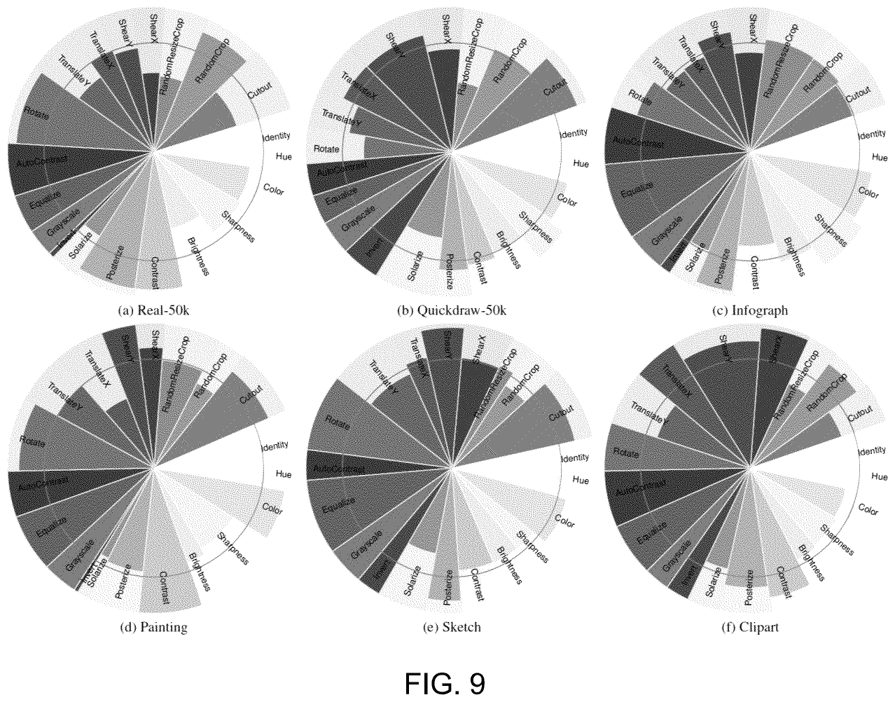

ImageNet-100: The best policy found for ImageNet-100 is illustrated in FIG. 8. Notably, RandomResizeCrop was ranked quite low, yet the example policy yielded results comparable to TrivialAugment's (with an 86.18 average accuracy on this split), suggesting that other geometrical transformations such as Cutout, Rotate, and ShearY were equivalently beneficial for training on ImageNet-100. Rather high magnitude upper-bounds for the color jittering transformation TrivialAugment also applied by default (Color, Contrast, Brightness), which is consistent with the higher performance of TrivialAugment's (Wide) version compared to (RA).

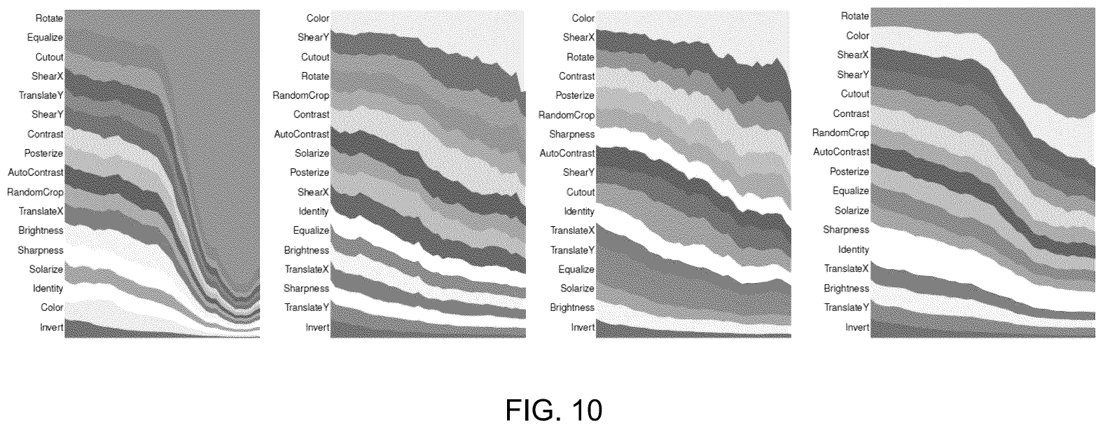

DomainNet: The policies found by the inventive method (SLACK) on DomainNet are illustrated in the pie charts in FIG. 9 for all domains. The three distributions from π forming the composite transformation were averaged.

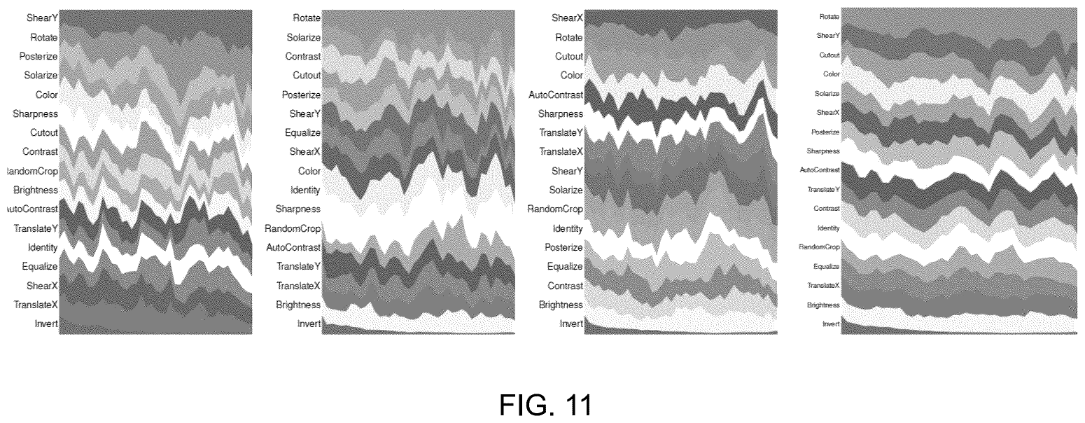

FIG. 10 shows evolution of the probability distributions π for CIFAR100 with unregularized unrolled optimization in a case of collapse, where the three left images show the three distributions over transformations forming the composition, and the right figure shows an average of the three distributions.

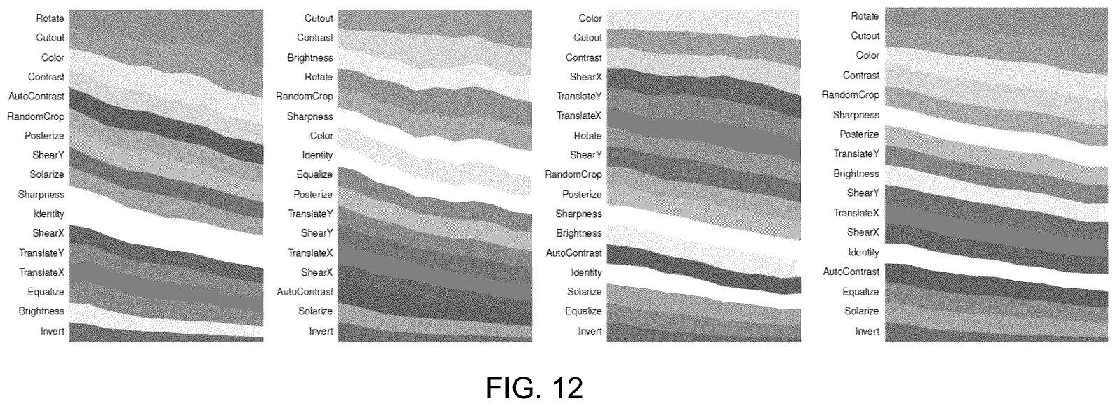

FIG. 11 shows evolution of the distributions π for CIFAR100 with entropy-regularized unrolled optimizations, on one of the search splits, where the three left images show the three distributions over transformations forming the composition, and the right figure shows an average of the three distributions.

Some similarities with policies found on CIFAR and ImageNet can be noted. In particular, Invert and Solarize (that only inverts part of the pixels) were systematically discarded for all domains except Quickdraw. Invert was manually removed from TrivialAugment's baseline, as it is known to be detrimental, and this appeared to generalize to other domains. Also, Rotate and Cutout were globally favored, similarly to the policies found on CIFAR and ImageNet-100.

However, some differences marked specificities to each domain: (i) on the strength of their transformations: for example, geometrical transformations were given high magnitudes on Clipart and lower ones on Real, (ii) on their probabilities: color jittering transformations used for real images were globally assigned a high probability for Real, Painting, and Infograph domains, and a much lower one for Clipart, which suggested that changes in color, contrast, or brightness were less meaningful for this domain.

Avoiding instabilities: The evolution of augmentation policies was assessed when removing the KL regularization or when using a single optimization stage instead of multiple ones, which corresponds to standard unrolled optimization. Evaluations for both settings are shown in Table 12, which shows CIFAR10/100 accuracy with unregularized and single-stage approaches.

TABLE 12

| | Upper- | | | | | | |
|---|---|---|---|---|---|---|---|
| SLACK | level | Upper- | KL | CIFAR10 | | CIFAR100 | |
| variant | iterations | level lr | weight | WRN-40-2 | WRN-28-10 | WRN-40-2 | WRN-28-10 |
| Unrolled | 10000 | 0.25 | 0.005 | 96.30 ± .08 | 97.43 ± .04 | 79.54 ± .20 | 84.11 ± .13 |
| w/KL | | | | | | | |
| (FIG. 5) | | | | | | | |
| SLACK | 10 × 400 | 0.25 | 0 | 96.27 ± .05 | 97.06 ± .11 | 79.61 ± .13 | 83.79 ± .19 |
| w/o KL | | | | | | | |
| (FIG. 6) | | | | | | | |
| SLACK | 10 × 400 | 1 | 0.02 | 96.29 ± .08 | 97.46 ± .06 | 79.87 ± .11 | 84.08 ± .16 |
| (FIG. 1) | | | | | | | |

Table 12 shows that unrolled optimization was globally unstable and easily collapsed, illustrating the benefit of a regularization. The table illustrates how entropy regularization prevents collapse and yields competitive results, but at the cost of high ‘local’ instability. These instabilities make the final performance highly dependent on the choice of some hyperparameters, such as the learning rate. Such instabilities can be addressed using multi-stage approaches with adaptive anchoring for the regularization as provided in example methods. Additionally, unregularized multi-stage optimization, while more stable than unregularized unrolled optimization, did not yield competitive results, further illustrating benefits of KL regularization.

Unregularized unrolled optimization: Unrolled optimization is subject to two sources of instability. One source is that the approximation θ*(ϕ)=\hat{θ}(ϕ) with a single gradient step inherently leads to wrong gradient updates. Another source is that the REINFORCE gradient estimation is theoretically exact but has a high variance in operation when approximated in the context of stochastic optimization. FIG. 10 illustrates these instabilities: blindly following wrong gradient directions exacerbated by an oversampling of the dominant transformation led to a progressive collapse of the policy.

Unrolled optimization with entropy regularization: For the case of a single-stage unrolled optimization, the KL regularization uses a uniform distribution as an anchor, which corresponds to an entropy regularization. By maximizing the entropy, this approach can encourage exploration of the augmentation policies and prevent the divergence phenomenon observed above. While this regularization led to competitive results as shown in Table 12, it did not mitigate the inherent stability of the gradient updates. Further providing a multi-stage method as in example embodiments can yield more stable gradient updates.

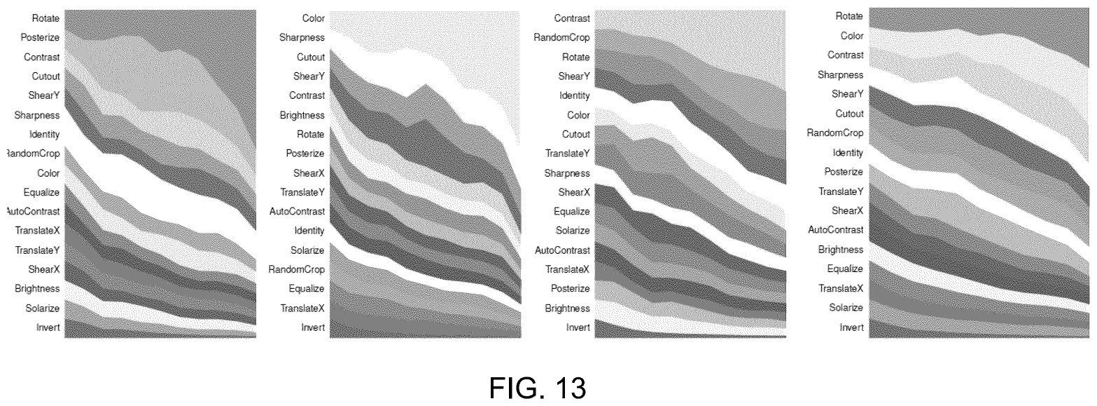

Multi-stage optimization without KL regularization: In multi-stage approaches of example methods, θ*(\tilde{ϕ}) is well-approximated at the beginning of each stage, as the model is retrained with the current policy \tilde{ϕ}. Gradient updates close to this policy are ‘trusted’ since the current θ after retraining stays close to θ*(\tilde{ϕ}), meaning that example methods strongly mitigate the approximation inherent to unrolled optimization. The KL regularization in example methods encourages the policy to stay in this trust region, as without it, the stochasticity of the optimization combined with the high variance from REINFORCE may drive the policy away. FIGS. 12-13 show the evolution of example probability distributions π for CIFAR100 under an unregularized multi-stage search using upper-level learning rates of 0.25 and 0.5, where the three left images show the three distributions over transformations forming the composition, and the right figure shows an average of the three distributions.

This evolution was smoother than with single-stage unrolled optimization and was also quite stable when using a small learning rate, but this slowed down convergence, yielding a suboptimal policy, as shown in Table 12. The larger one led again to a progressive divergence; the policy was driven too far and the θ*(\tilde{ϕ}) obtained after retraining became suboptimal for the current ϕ. Put another way, the example KL regularization allows making large updates in the parameter space, while remaining close to a reference/anchor policy.

Ensembling approach: The effect of an ensembling approach for example methods to reduce the variance of gradient updates in the search phase was considered. An example approach includes independently training multiple models on the lower-level loss while averaging their contributions to the upper-level gradient. Each model was initialized (and subsequently re-initialized at each stage) based on a pretraining with a different seed. This ensembling strategy was implemented using multiple GPUs, where each GPU trained one copy of the model and only the upper-level gradients were communicated and averaged across GPUs.

Results on CIFAR10/100 are shown in Table 13. While there was a small improvement in most cases, the method still had a strong computational overhead. However, such an approach may be more beneficial for datasets for which the training procedure has a higher variance, such as for smaller datasets where the additional cost of ensembling is not a significant overhead.

TABLE 13

| | @ | | CIFAR100 | |
|---|---|---|---|---|
| | WRN-40-2 | WRN-28-10 | WRN-40-2 | WRN-28-10 |
| SLACK | 96.29 ± .08 | 97.46 ± .06 | 79.87 ± .11 | 84.08 ± .16 |
| Ensembling | 96.33 ± .08 | 97.48 ± .06 | 79.94 ± .13 | 84.01 ± .14 |
| of SLACK | | | | |
| (4 GPUs) | | | | |

Warm-start versus cold-start: The model behavior when searching with warm-start instead of cold-start was considered. “Warm-start” refers to performing retraining starting from the current neural network model's weights at the beginning of each stage instead of reinitializing it to its pretrained weights. Experiments indicated that warm-start with the same hyperparameters as for cold-start led to a progressive over-fitting of the neural network. Increasing the lower-level learning rate mitigated this phenomenon, but still yielded suboptimal results, as shown in Table 14. This suggests that retraining from θ*₀(ϕ₀) provides a better estimate of θ*(ϕᵢ) at stage i than re-training from the biased state close to θ*(ϕᵢ₋₁).

TABLE 14

| | CIFAR10 | | CIFAR100 | |
|---|---|---|---|---|
| SLACK variant | WRN-40-2 | WRN-28-10 | WRN-40-2 | WRN-28-10 |
| Warm-start | 96.27 ± .09 | 97.05 ± .15 | 79.70 ± .11 | 83.90 ± .10 |
| Cold-start | 96.29 ± .08 | 97.46 ± .06 | 79.87 ± .11 | 84.08 ± .16 |
| (ours) | | | | |

Table 15 shows CIFAR 10/100 accuracy with ensembling strategy.

TABLE 15

| | CIFAR10 | | CIFAR100 | |
|---|---|---|---|---|
| | WRN-40-2 | WRN-28-10 | WRN-40-2 | WRN-28-10 |
| SLACK | 96.29 ± .08 | 97.46 ± .06 | 79.87 ± .11 | 84.08 ± .16 |
| Ensembling | 96.33 ± .08 | 97.48 ± .06 | 79.94 ± .13 | 84.01 ± .14 |
| of SLACK | | | | |
| (4 GPUs) | | | | |

Table 16 shows CIFAR10/100 accuracy with cold start and warm start.

TABLE 16

| | CIFAR10 | | CIFAR100 | |
|---|---|---|---|---|
| SLACK variant | WRN-40-2 | WRN-28-10 | WRN-40-2 | WRN-28-10 |
| Warm-start | 96.27 ± .09 | 97.05 ± .15 | 79.70 ± .11 | 83.90 ± .10 |
| Cold-start | 96.29 ± .08 | 97.46 ± .06 | 79.87 ± .11 | 84.08 ± .16 |
| (ours) | | | | |

FIG. 7 shows illustrations of best policies found for CIFAR10 and CIFAR100 on WideResNet-40x2 and WideResNet-28x10 architectures. For each dataset and architecture, FIG. 7 shows the evolution of the probability distribution π as training progresses (left) and the final learned policy as a pie chart (right), where slice widths represent π and slice radii represent μ. FIG. 8 shows ImageNet-100 policy on the best search split.

### Network Architecture

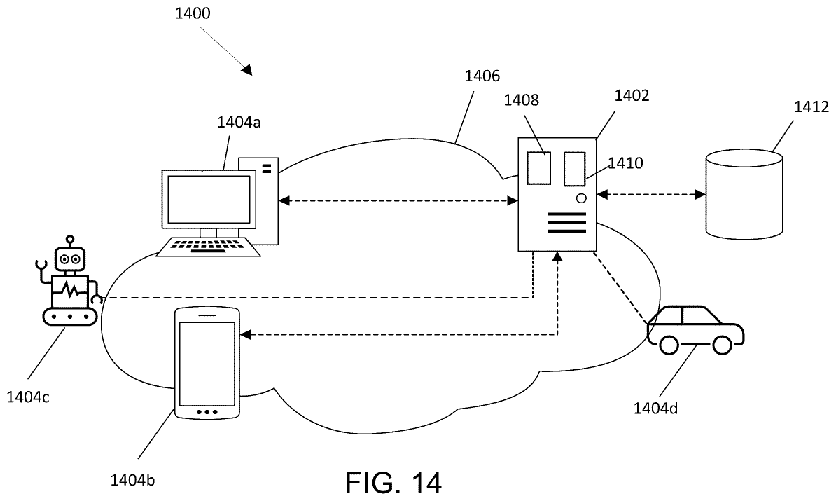

Example systems, methods, and embodiments may be implemented within a network architecture 1400 such as illustrated in FIG. 14, which comprises a server 1402 and one or more client devices 1404 that communicate over a network 1406 which may be wireless and/or wired, such as the Internet, for data exchange. The server 1402 and the client devices 1404a, 1404b can each include a processor, e.g., processor 1408 and a memory, e.g., memory 1410 (shown by example in server 1402), such as but not limited to random-access memory (RAM), read-only memory (ROM), hard disks, solid state disks, or other non-volatile storage media. Memory 1410 may also be provided in whole or in part by external storage in communication with the processor 1408. The server 1402, for example, may be embodied in one or more computers. Reference herein to “computer” or “a computer” is intended to refer to one or more computers.

The data augmentation model for augmenting data (e.g., transforming images, though other augmentations are possible) and/or the neural network model for performing a task (e.g., an image classification task, though other tasks are possible), may be embodied in the server 1402 and/or client devices 1404. It will be appreciated that the processor 1408 can include either a single processor or multiple processors operating in series or in parallel, and that the memory 1410 can include one or more memories, including combinations of memory types and/or locations. Server 1402 may also include, but are not limited to, dedicated servers, cloud-based servers, or a combination (e.g., shared). Storage, e.g., a database, may be embodied in suitable storage in the server 1402, client device 1404, a connected remote storage 1412 (shown in connection with the server 1402, but can likewise be connected to client devices), or any combination.

Client devices 1404 may be any processor-based device, terminal, etc., and/or may be embodied in a client application executable by a processor-based device, etc. Client devices may be disposed within the server 1402 and/or external to the server (local or remote, or any combination) and in communication with the server. Example client devices 1404 include, but are not limited to, autonomous computers 1404a, mobile communication devices (e.g., smartphones, tablet computers, etc.) 1404b, robots 1404c, autonomous vehicles 1404d, wearable devices, virtual reality, augmented reality, or mixed reality devices (not shown), or others. Client devices 1404 may be configured for sending data to and/or receiving data from the server 1402, and may include, but need not include, one or more output devices, such as but not limited to displays, printers, etc. for displaying or printing results of certain methods that are provided for display by the server. Client devices may include combinations of client devices.

In an example data augmentation policy training method, the server 1402 or client devices 1404 may receive a dataset, e.g., of a particular data distribution, from any suitable source, e.g., from memory 1410 (as nonlimiting examples, internal storage, an internal database, etc.), from external (e.g., remote) storage 1412 connected locally or over the network 1406. The example data augmentation policy training method can receive and train and/or use for training, a data augmentation model (augmentation policy), e.g., including or represented by data augmentation parameters and/or a neural network model, e.g., including or represented by neural network model parameters, each of which can be likewise stored in the server (e.g., memory 1410), client devices 1404, external storage 1412, or combination. In some example embodiments provided herein, training of the data augmentation model (augmentation policy), training of the neural network performing a task using data augmented by the trained data augmentation policy, or and/or inference by the trained neural network model (e.g., in performance of an image classification task) may be performed offline or online (e.g., at run time), in any combination. Results can be output (e.g., displayed, transmitted, provided for display, printed, etc.) and/or stored for retrieving and providing on request.

One or more of the server 1402 or client devices 1404 may be provided with one or more imaging devices (CCDs, energy sensors, cameras, etc.) for directly or indirectly receiving images (or image signals) of various origins and types for processing by trained neural network models, e.g., trained using augmented data generated using a learned data augmentation policy. The image signals can be received locally or remotely, either directly or via a suitable interface, or from another of the server or client devices connected locally or over the network 1406. Trained data augmentation models (which may also be neural network-based models or other configured and parameterized models) and/or neural network models trained or to be trained for performing tasks can be likewise stored in the server (e.g., memory 1410), client devices 1404, external storage 1412, or combination. Results of such models can be output (e.g., displayed, transmitted, provided for display, printed, etc.) and/or stored for retrieving and providing on request.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

### General

Embodiments herein provide, among other things, a computer-implemented method for training a data augmentation policy, the method comprising: pretraining a neural network having neural network parameters on a task on a training dataset, the training dataset being augmented by an initial augmentation policy; initializing the data augmentation policy with the initial data augmentation policy to define a current data augmentation policy; and iteratively training the data augmentation policy using bilevel optimization, wherein said iteratively training comprises, for each of n rounds, where n≥1: initializing the neural network parameters of the neural network with the neural network parameters trained during said pretraining; and, over a plurality of steps, training the neural network on the task to update the neural network parameters on the training dataset, the training dataset being augmented by the current data augmentation policy for the current step; and updating the data augmentation policy based on said updated neural network parameters to define the current data augmentation policy for the next step or the data augmentation policy on the last round. In addition to any of the above features in this paragraph, updating the data augmentation policy may use a gradient computed using a score-based method. In addition to any of the above features in this paragraph, the score-based method may comprises a REINFORCE method. In addition to any of the above features in this paragraph, said updating the data augmentation policy may further use a divergence or entropy-based regularization. In addition to any of the above features in this paragraph, the divergence or entropy-based regularization may comprise a Kullback-Leibler (KL) regularization. In addition to any of the above features in this paragraph, said updating the data augmentation policy may comprise: training the data augmentation policy using the trained neural network with the updated neural network parameters on a validation dataset that is separate from the training dataset, without data augmentation, to update data augmentation policy parameters of the data augmentation policy. In addition to any of the above features in this paragraph, n may be greater than 1. In addition to any of the above features in this paragraph, the initial augmentation policy may comprise a uniform policy. In addition to any of the above features in this paragraph, the data augmentation policy may comprise: a categorical distribution of data transformations; and a continuous distribution of magnitudes for each data transformation; wherein the data augmentation policy may generate a data augmentation by: selecting K data transformations from the categorical distribution, where K is at least one; selecting values for magnitudes for each of the selected K data transformations; and composing the K data transformations to obtain the data augmentation. In addition to any of the above features in this paragraph, the data transformations may comprise elementary transformations; and the categorical distribution may be parameterized by a logit vector. In addition to any of the above features in this paragraph, the data transformations may comprise elementary transformations sᵢ in a set S from which elementary transformations t are sampled; wherein magnitudes m of each selected elementary transformation tᵢ in S in the data augmentation policy may be sampled from a smoothed uniform distribution between [0,μᵢ] whose upper bound μᵢ is learned during each round. In addition to any of the above features in this paragraph, the smoothed uniform distribution may be obtained from a Gaussian distribution. In addition to any of the above features in this paragraph, said updating the data augmentation policy may further use a divergence or entropy-based regularization; and the regularization may force the current data augmentation policy to stay close to an anchor policy that comprises an updated data augmentation policy from a prior round. In addition to any of the above features in this paragraph, said training the neural network may comprise computing a stochastic gradient of a loss over the neural network parameters. In addition to any of the above features in this paragraph, said updating the data augmentation policy may comprise computing a stochastic gradient of a loss over data augmentation parameters of the data augmentation policy. In addition to any of the above features in this paragraph, said training the neural network may approximate an optimal inner-level solution using a sequence of differentiable optimization steps. In addition to any of the above features in this paragraph, iteratively training may further comprise: over an additional plurality of steps, training the neural network on the task to update the neural network parameters on the training dataset without updating the data augmentation policy, the training dataset being augmented by the current data augmentation policy for the current step. In addition to any of the above features in this paragraph, the data augmentation policy may comprise a composite of multiple transformations; and the method may learn a categorical probability distribution over the multiple transformations and a continuous distribution of a magnitude of each of the multiple transformations. In addition to any of the above features in this paragraph, the multiple transformations may each comprise elementary transformations. In addition to any of the above features in this paragraph, the continuous distribution of the magnitude of each of the multiple transformations may be obtained from a combination of one or more Gaussian distributions. In addition to any of the above features in this paragraph, the training may incorporate a regularization mechanism. In addition to any of the above features in this paragraph, the regularization mechanism may be entropy-based. In addition to any of the above features in this paragraph, the regularization mechanism may be based on an entropy formulation whose strength decays of training iterations. In addition to any of the above features in this paragraph, the data may comprises image data, and the data augmentation may comprise transforming the image data. In addition to any of the above features in this paragraph, the task may comprise an image classification task. In addition to any of the above features in this paragraph, the neural network may comprise a convolutional neural network (CNN). In addition to any of the above features in this paragraph, the method may further comprise: generating augmented data from a dataset using the trained data augmentation policy; and training the neural network or a different neural network on the task using the augmented data. In addition to any of the above features in this paragraph, said updating the data augmentation policy may comprise training the data augmentation policy on a validation dataset that is separate from the training dataset starting from the trained neural network with the updated neural network parameters without data augmentation on the validation dataset, to update data augmentation policy parameters of the data augmentation policy; and the training dataset and the validation dataset may be taken from the dataset. In addition to any of the above features in this paragraph, the method may further comprise: evaluating the trained neural network on the task using a testing dataset that is separate from the dataset, without data augmentation on the testing dataset. In addition to any of the above features in this paragraph, said updating the data augmentation policy may comprise training the data augmentation policy on a validation dataset that is separate from the training dataset starting from the trained neural network with the updated neural network parameters without data augmentation on the validation dataset, to update data augmentation policy parameters of the data augmentation policy; and the dataset may be from a different domain as the training dataset and the evaluation dataset. In addition to any of the above features in this paragraph, the data may comprise image data; the data augmentation may comprise transforming the image data using one or more image transformations; and the task may comprise classifying a visual input. In addition to any of the above features in this paragraph, the visual input may comprise natural images, medical images, sketches, spectral images, and/or infrared images. In addition to any of the above features in this paragraph, the method may learn the data augmentation policy without using default transformations or hand-selected magnitude ranges.

Additional embodiments provide, among other things, a computer-implemented method for learning a data augmentation policy represented by data augmentation parameters, the method comprising: initializing the data augmentation policy; initializing neural network parameters of a neural network with neural network parameters trained during a pretraining, wherein said pretraining uses data augmented by the initialized data augmentation policy; training a neural network on a task to update neural network parameters on a training dataset augmented by a current augmentation policy; and updating the data augmentation policy based on the updated neural network parameters using an evaluation dataset that is separate from the training dataset, without augmenting the evaluation dataset, to define the current data augmentation policy for the next step or the data augmentation policy on the last round; wherein the data augmentation policy comprises: a categorical distribution of data transformations; and a continuous distribution of magnitudes for each data transformation. In addition to any of the above features in this paragraph, said initializing neural network parameters, said training a neural network, and said updating the data augmentation policy may be performed (e.g., each be performed) over each of one or more rounds; wherein said training a neural network and said updating the data augmentation policy may be performed over each of a plurality of steps within each round. In addition to any of the above features in this paragraph, the continuous distribution of magnitudes for each data transformation may comprise a smoothed uniform distribution parameterized by an upper bound. In addition to any of the above features in this paragraph, the method may further comprise: over an additional plurality of steps within each round, training the neural network on the task to update the neural network parameters on the training dataset without updating the data augmentation policy, the training dataset being augmented by the current data augmentation policy for the current step. Example embodiments under this paragraph may further be combined with any of the features in the previous paragraph.

Additional embodiments provide, among other things, a computer-implemented system for training a data augmentation policy represented by data augmentation parameters, the system comprising: a processor; a memory; and executable instructions stored in the memory for causing the processor to perform a method according to either of the prior two paragraphs. Further embodiments provide, among other things, an apparatus for training a data augmentation policy represented by data augmentation parameters comprising: a non-transitory computer-readable medium having executable instructions stored thereon for causing a processor and a memory to perform a method according to either of the prior two paragraphs.

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure. All documents referred to herein are incorporated herein by reference in their entirety, without any admission that such documents constitute prior art.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for training a data augmentation policy, the method comprising:
pretraining a neural network having neural network parameters on a task on a training dataset, the training dataset being augmented by an initial augmentation policy;
initializing the data augmentation policy with the initial data augmentation policy to define a current data augmentation policy; and
iteratively training the data augmentation policy using bilevel optimization, wherein said iteratively training comprises, for each of n rounds, where n≥1:
initializing the neural network parameters of the neural network with the neural network parameters trained during said pretraining; and
over a plurality of steps,
training the neural network on the task to update the neural network parameters on the training dataset, the training dataset being augmented by the current data augmentation policy for the current step; and
updating the data augmentation policy based on said updated neural network parameters to define the current data augmentation policy for the next step or the data augmentation policy on the last round.

2. The method of claim 1,
wherein said updating the data augmentation policy uses a gradient computed using a score-based method.

3. (canceled)

4. The method of claim 2,
wherein said updating the data augmentation policy further uses a divergence or entropy-based regularization.

5. (canceled)

6. The method of claim 1,
wherein said updating the data augmentation policy comprises:
training the data augmentation policy using the trained neural network with the updated neural network parameters on a validation dataset that is separate from the training dataset, without data augmentation, to update data augmentation policy parameters of the data augmentation policy.

7. The method of claim 1, wherein n>1.

8. The method of claim 1,
wherein the initial augmentation policy comprises a uniform policy.

9. The method of claim 1,
wherein the data augmentation policy comprises:
a categorical distribution of data transformations; and
a continuous distribution of magnitudes for each data transformation;
wherein the data augmentation policy generates a data augmentation by:
selecting K data transformations from the categorical distribution, where K is at least one;
selecting values for magnitudes for each of the selected K data transformations; and
composing the K data transformations to obtain the data augmentation.

10. (canceled)

11. The method of claim 9,
wherein the data transformations comprise elementary transformations sᵢ in a set S from which elementary transformations t are sampled; and
wherein magnitudes m of each selected elementary transformation tᵢ in S in the data augmentation policy are sampled from a smoothed uniform distribution between [0, μᵢ] whose upper bound μᵢ is learned during each round.

12. (canceled)

13. The method of claim 1,
wherein said updating the data augmentation policy further uses a divergence or entropy-based regularization; and
wherein the regularization forces the current data augmentation policy to stay close to an anchor policy that comprises an updated data augmentation policy from a prior round.

14. The method of claim 1,
wherein said training the neural network comprises computing a stochastic gradient of a loss over the neural network parameters; and
wherein said updating the data augmentation policy comprises computing a stochastic gradient of a loss over data augmentation parameters of the data augmentation policy.

15. (canceled)

16. The method of claim 1,
wherein said training the neural network approximates an optimal inner-level solution using a sequence of differentiable optimization steps.

17. The method of claim 1,
wherein iteratively training further comprises:
over an additional plurality of steps, training the neural network on the task to update the neural network parameters on the training dataset without updating the data augmentation policy, the training dataset being augmented by the current data augmentation policy for the current step.

18. The method of claim 1,
wherein the data augmentation policy comprises a composite of multiple transformations; and
wherein the method learns a categorical probability distribution over the multiple transformations and a continuous distribution of a magnitude of each of the multiple transformations.

19. (canceled)

20. (canceled)

21. The method of claim 1,
wherein the training incorporates a regularization mechanism;
wherein the regularization mechanism is entropy-based.

22. (canceled)

23. The method of claim 1,
wherein the training incorporates a regularization mechanism;
wherein the regularization mechanism is based on an entropy formulation whose strength decays over training iterations.

24. The method of claim 1,
wherein the data comprises image data, and wherein the data augmentation comprises transforming the image data.

25. The method of claim 24,
wherein the task comprises an image classification task.

26. The method of claim 24,
wherein the neural network comprises a convolutional neural network (CNN).

27. The method of claim 1, further comprising:
generating augmented data from a dataset using the trained data augmentation policy; and
training the neural network or a different neural network on the task using the augmented data.

28. The method of claim 27,
wherein said updating the data augmentation policy comprises training the data augmentation policy on a validation dataset that is separate from the training dataset starting from the trained neural network with the updated neural network parameters without data augmentation on the validation dataset, to update data augmentation policy parameters of the data augmentation policy; and
wherein the training dataset and the validation dataset are taken from the dataset.

29. The method of claim 27,
wherein the method further comprises:
evaluating the trained neural network on the task using a testing dataset that is separate from the dataset, without data augmentation on the testing dataset.

30. The method of claim 27,
wherein said updating the data augmentation policy comprises training the data augmentation policy on a validation dataset that is separate from the training dataset starting from the trained neural network with the updated neural network parameters without data augmentation on the validation dataset, to update data augmentation policy parameters of the data augmentation policy; and
wherein the dataset is from a different domain as the training dataset and the evaluation dataset.

31. (canceled)

32. The method of claim 1,
wherein the data comprises image data;
wherein the data augmentation comprises transforming the image data using one or more image transformations; and
wherein the task comprises classifying a visual input;
wherein the visual input comprises natural images, medical images, sketches, spectral images, and/or infrared images.

33. The method of claim 1,
wherein the data comprises image data;
wherein the data augmentation comprises transforming the image data using one or more image transformations; and
wherein the task comprises classifying a visual input;
wherein the method learns the data augmentation policy without using default transformations or hand-selected magnitude ranges.

34. A computer-implemented method for learning a data augmentation policy represented by data augmentation parameters, the method comprising:
initializing the data augmentation policy;
initializing neural network parameters of a neural network with neural network parameters trained during a pretraining, wherein said pretraining uses data augmented by the initialized data augmentation policy;
training a neural network on a task to update neural network parameters on a training dataset augmented by a current augmentation policy; and
updating the data augmentation policy based on the updated neural network parameters using an evaluation dataset that is separate from the training dataset, without augmenting the evaluation dataset, to define the current data augmentation policy for the next step or the data augmentation policy on the last round;
wherein the data augmentation policy comprises:
a categorical distribution of data transformations; and
a continuous distribution of magnitudes for each data transformation.

35. The method of claim 34,
wherein said initializing neural network parameters, said training a neural network, and said updating the data augmentation policy are each performed over each of one or more rounds;
wherein said training a neural network and said updating the data augmentation policy are performed over each of a plurality of steps within each round.

36. The method of claim 34,
wherein the continuous distribution of magnitudes for each data transformation comprises a smoothed uniform distribution parameterized by an upper bound.

37. The method of claim 35,
wherein the method further comprises:
over an additional plurality of steps within each round, training the neural network on the task to update the neural network parameters on the training dataset without updating the data augmentation policy, the training dataset being augmented by the current data augmentation policy for the current step.

38. A computer-implemented system for training a data augmentation policy represented by data augmentation parameters, the system comprising:
a processor;
a memory; and
executable instructions stored in the memory for causing the processor to perform a method comprising:
pretraining a neural network having neural network parameters on a task on a training dataset, the training dataset being augmented by an initial augmentation policy;
initializing the data augmentation policy with the initial data augmentation policy to define a current data augmentation policy; and
iteratively training the data augmentation policy using bilevel optimization, wherein said iteratively training comprises, for each of n rounds, where n≥1:
initializing the neural network parameters of the neural network with the neural network parameters trained during said pretraining; and
over a plurality of steps,
training the neural network on the task to update the neural network parameters on the training dataset, the training dataset being augmented by the current data augmentation policy for the current step; and
updating the data augmentation policy based on said updated neural network parameters to define the current data augmentation policy for the next step or the data augmentation policy on the last round.

39. An apparatus for training a data augmentation policy represented by data augmentation parameters comprising:
a non-transitory computer-readable medium having executable instructions stored thereon for causing a processor and a memory to perform a method comprising:
pretraining a neural network having neural network parameters on a task on a training dataset, the training dataset being augmented by an initial augmentation policy;
initializing the data augmentation policy with the initial data augmentation policy to define a current data augmentation policy; and
iteratively training the data augmentation policy using bilevel optimization, wherein said iteratively training comprises, for each of n rounds, where n≥1:
initializing the neural network parameters of the neural network with the neural network parameters trained during said pretraining; and
over a plurality of steps,
training the neural network on the task to update the neural network parameters on the training dataset, the training dataset being augmented by the current data augmentation policy for the current step; and
updating the data augmentation policy based on said updated neural network parameters to define the current data augmentation policy for the next step or the data augmentation policy on the last round.
